(19) United States
(12) Patent Application Publication
(10) Pub. No.: US 2025/0241732 A1
(43) Pub. Date: Jul. 31, 2025

(54) PREDICTING ACCURATE FABRICATION GEOMETRIES OF DENTAL APPLIANCES AND CORRESPONDING AUXILIARIES

(71) Applicant: Align Technology, Inc., San Jose, CA (US)

(72) Inventors: Yuxiang WANG, Newark, CA (US); Andrei SOLDATOV, Santa Clara, CA (US); Jun SATO, San Jose, CA (US); Siobhan O'LEARY, Santa Clara, CA (US); Manlio Fabio VALDIVIESO CASIQUE, Santa Clara, CA (US); Crystal TJHIA, Sunnyvale, CA (US); Jessica H. SCHILTZ, San Jose, CA (US); Shipin QIN, San Jose, CA (US); Kangning SU, Pullman, WA (US)

(21) Appl. No.: 19/043,381

(22) Filed: Jan. 31, 2025

Related U.S. Application Data
(60) Provisional application No. 63/627,745, filed on Jan. 31, 2024.

(51) Int. Cl. A61C 7/00; G06F 30/12

(52) U.S. Cl. CPC A61C 7/002; G06F 30/12

(57) ABSTRACT

Methods for updating a geometry of an initial 3D model of a dental auxiliary or a dental appliance to conform to an engaging surface of a corresponding dental component to provide better force systems as part of an orthodontic treatment. Any of these methods may include predicting the updated geometry of the initial 3D model data.

### CLAIM OF PRIORITY

This patent application claims priority to U.S. Provisional Patent Application No. 63/627,745, titled “DENTAL COMPONENT UPDATED GEOMETRY PREDICTION” and filed on Jan. 31, 2024, herein incorporated by reference in its entirety.

### INCORPORATION BY REFERENCE

All publications and patent applications mentioned in this specification are herein incorporated by reference to the same extent as if each individual publication or patent application was specifically and individually indicated to be incorporated by reference.

### BACKGROUND

A dental appliance (“appliance) used as part of an orthodontic treatment may be adapted to be worn over one or more patient's teeth. The appliance may be configured to engage with one or more dental auxiliaries (“auxiliaries,” or “auxiliary”) that are secured or fixed to one of the more of the patient's teeth. The auxiliary and the appliance may be designed so that engagement between the auxiliary and a corresponding structure of the appliance causes the application of one or more forces (retention, tooth movement, lateral expansion, etc. forces) to the patient's dentition to facilitate an orthodontic treatment. Optimal engagement between the appliance and auxiliary translates to optimal forces to facilitate the orthodontic treatment.

There may be a variety of reasons for insufficient engagement between fabricated geometries of an auxiliary and a corresponding engaging surface of an appliance, resulting in less than ideal forces. For example only, different fabricating or manufacturing techniques for the auxiliary and the appliance may result in less than ideal engaging geometries. Solutions are needed that can provide conforming geometries between fabricated auxiliaries and a corresponding engaging surface of a fabricated dental appliance to create desired force systems according to an orthodontic treatment.

### SUMMARY OF THE DISCLOSURE

One aspect of the disclosure herein is related to updating at least one surface of a 3D model of an auxiliary or an appliance to create an updated geometry so that the fabricated engaging surfaces will more closely conform with one another, thereby creating better engagement and/or force systems to facilitate the orthodontic treatment. The disclosure herein may find application in updating a surface of an auxiliary, or in updating a surface of an appliance. The disclosure herein may find applications in updating a variety of surfaces of dental components to more closely conform to the geometry of a surface of a different dental component.

One aspect of the disclosure is a method of forming a dental auxiliary. The method may include receiving or generating, by a processor, an initial 3D model of a dental auxiliary; predicting, by the processor, an updated geometry of the initial 3D model of the dental auxiliary to conform to an auxiliary well of a dental appliance; and generating a digital representation of the dental auxiliary based on the updated geometry.

In this aspect, predicting the updated geometry may include identifying an error surface on the initial 3D model of the dental auxiliary, wherein the error surface corresponds to a surface of the attachment well predicted to deviate from an original design of the dental appliance; and modifying the error surface of the 3D model of the dental auxiliary to create an updated surface. The updated geometry defines a modified geometry that is different from the initial geometry of the 3D model of the dental auxiliary.

One aspect of this disclosure is a method forming a dental appliance. The method may include receiving or generating, by a processor, an initial 3D model of a dental appliance; predicting, by the processor, an updated geometry of the 3D model of the dental appliance to conform to a dental auxiliary; and generating a digital representation of the dental appliance based on the updated geometry.

In this aspect, predicting the updated geometry may include identifying an error surface on the initial 3D model of the dental appliance, wherein the error surface corresponds to a surface of the dental auxiliary that is predicted to deviate from an original design of the dental auxiliary; and modifying the error surface of the 3D model of the dental appliance to create an updated surface. The updated geometry defines a modified geometry that is different from the initial 3D model of a dental appliance.

The methods of prediction herein that predict an updated geometry of a dental component may be performed by models that have been trained to predict the updated geometry, such as with supervised machine learning algorithms trained with inputs and targets.

One aspect of the disclosure is a method of training a machine learning prediction model to predict an updated geometry of a 3D model of a dental auxiliary to conform to an auxiliary well of a dental appliance. The method may include providing 3D models of a plurality of dental auxiliaries, each including an error surface; providing 3D models of a plurality of dental appliances that each include an auxiliary receiving well; identifying a plurality of sampling points on each of the error surfaces; identifying a plurality of training features associated with each of the plurality of sampling points; and providing one or more target distances from each of the plurality of sampling points to a surface of the auxiliary receiving well to train the prediction model with the plurality of features associated with each of the plurality of sampling points and the target distances. Once trained, the trained prediction model is adapted to receive as input an initial 3D model of a dental auxiliary and, based on the initial 3D model of a dental auxiliary, predict an updated geometry of the 3D model of the dental auxiliary to conform to an auxiliary well of the dental appliance.

One aspect of the disclosure is a method of training a machine learning prediction model to predict an updated geometry of a 3D model of a dental appliance to conform to an auxiliary. The method may include providing 3D models of a plurality of dental appliances, each including an error surface in an auxiliary well; providing 3D models of a plurality of dental auxiliaries; identifying a plurality of sampling points on each of the error surfaces; identifying a plurality of features associated with each of the plurality of sampling points; and providing one or more target distances from each of the plurality of sampling points to a surface of the auxiliary to train the prediction model with the plurality of features associated with each of the plurality of sampling points and the target distances. Once trained, the trained prediction model is adapted to receive as input an initial 3D model of a dental appliance and, based on the initial 3D model of the dental appliance, predict an updated geometry of the 3D model of the dental appliance to conform to an auxiliary.

One aspect of the disclosure is a system that includes one or more processors and a memory coupled to the one or more processors, the memory storing computer-program instructions, that, when executed by the one or more processors, perform a computer-implemented method. The computer implemented methods may be any of the methods herein, including those including a trained model to predict any of the updated geometries herein.

In this aspect, the computer-implemented method may include receiving or generating, by a processor, an initial 3D model of a dental auxiliary; predicting, by the processor, an updated geometry of the 3D model of the dental auxiliary to conform to an auxiliary well of a dental appliance; and generating a digital representation of the dental auxiliary based on the updated geometry. Predicting the updated geometry may include identifying an error surface on the initial 3D model of the dental auxiliary, wherein the error surface corresponds to a surface of the attachment well predicted to deviate from an original design of the dental appliance; and modifying the error surface of the 3D model of the dental auxiliary to create an updated surface. The updated geometry defines a modified geometry that is different from the initial geometry of the 3D model of the dental auxiliary.

In this aspect, the computer-implemented method may include receiving or generating, by a processor, an initial 3D model of a dental appliance; predicting, by the processor, an updated geometry of the 3D model of the dental appliance to conform to a dental auxiliary; and generating a digital representation of the dental appliance based on the updated geometry. Predicting the updated geometry may include identifying an error surface on the initial 3D model of the dental appliance, wherein the error surface corresponds to a surface of the dental auxiliary that is predicted to deviate from an original design of the dental auxiliary; and modifying the error surface of the 3D model of the dental appliance to create an updated surface. The updated geometry defines a modified geometry that is different from the initial 3D model of a dental appliance.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1 illustrates an exemplary 3D model of an auxiliary.

FIG. 2 illustrates an exemplary physical model of dentition and an auxiliary.

FIG. 3 illustrates an exemplary process of indirectly forming an appliance.

FIGS. 4A and 4B illustrates model data of a tooth and an auxiliary.

FIGS. 5A, 5B and 5C illustrate an exemplary printing process that results in overcuring in a portion of a physical model.

FIGS. 6A, 6B and 6C illustrate and represent exemplary different fabrication techniques including exemplary different fabrication orientations that can lead to mismatch in geometries between interfacing surfaces of different dental components.

FIG. 7 illustrates a comparison between an initial 3D model of an auxiliary and a physical model including an overcured region of the auxiliary due to a fabrication process.

FIG. 8 illustrates a comparison between an initial 3D model of an auxiliary and a physical model including an overcured region of the auxiliary due to a fabrication process.

FIGS. 9A and 9B illustrate a comparison between a shape of an initial 3D model of an attachment and a shape of an indirectly formed template attachment.

FIG. 10 illustrates predicting an updated geometry that includes modifying an error surface of a 3D model of an auxiliary to create an updated, offset, surface.

FIG. 11 illustrates an exemplary method that is part of forming a dental auxiliary.

FIG. 12 illustrates an exemplary method of predicting an updated geometry of an initial 3D model of an auxiliary.

FIGS. 13A and 13B illustrate method of predicting an updated geometry of an initial 3D model of an auxiliary.

FIG. 14 illustrates an exemplary general method of training a machine learning algorithm or model.

FIG. 15 illustrates an exemplary process of training a machine learning algorithm or model.

FIGS. 16A and 16B illustrate portions of an exemplary process of training a machine learning algorithm or model.

FIG. 16C illustrates an exemplary coordinate system used in reference to examples and figures herein.

FIG. 17 illustrates an exemplary method of using a trained model to predict an updated geometry of an initial 3D model of a dental auxiliary.

FIG. 18 illustrates a composite or flash layer that can be used to predict an updated geometry of an auxiliary.

FIG. 19 illustrates exemplary directly fabricated auxiliaries with a support structure.

FIG. 20 illustrates an exemplary dental appliance, which may include one or more auxiliary wells as described herein.

FIG. 21 illustrates an exemplary method of forming a dental appliance.

FIG. 22 illustrates an exemplary method of predicting an updated geometry of an initial 3D model of a dental appliance.

FIG. 23 illustrates an exemplary general method of training a machine learning algorithm or model.

FIG. 24 illustrates an exemplary process of training a machine learning algorithm or model.

FIGS. 25, 26 and 27 illustrate predicting an updated geometry of a dental appliance that includes modifying an error surface of a 3D model of the appliance to create an updated, offset, appliance surface.

FIG. 28 illustrates an exemplary method of using a trained model to predict an updated geometry of an initial 3D model of a dental appliance.

FIG. 29 is a diagram illustrating one variation of a computing environment 2900.

### DETAILED DESCRIPTION

A dental appliance (“appliance”) part of a dental treatment (e.g., an orthodontic treatment) may be adapted to be worn over one or more of a patient's teeth. The appliance may be configured to engage with one or more dental auxiliaries (“auxiliaries,” or “auxiliary”) that are secured or fixed to one of the more of the patient's teeth. One or more auxiliaries as used herein may be referred to as a single auxiliary. The auxiliary and the appliance may be designed such that engagement between the auxiliary and a corresponding engaging structure of the appliance causes the application of one or more forces (e.g., retention, tooth movement, lateral expansion) to the patient's dentition to facilitate an orthodontic treatment. As such, an orthodontic treatment is generally more effective when the fabricated components, when worn, engage to create preferred forces to facilitate the orthodontic treatment.

While there may be a variety of reasons for insufficient engagement for which the innovative solutions described herein may find application, fabricating an appliance and an auxiliary with different manufacturing techniques may result in geometries of the corresponding engaging surfaces that engage insufficiently, sub-optimally, or less than ideally to facilitate the desired treatment. For example, fabricating an auxiliary and an application using different manufacturing processes (e.g., direct fabrication versus indirect fabrication) is an example of different manufacturing techniques herein that may result in corresponding surface geometries that may lead to smaller or unwanted force systems between the appliance and the auxiliary, or may otherwise cause the appliance and the auxiliary not to engage optimally. Additionally, for example, fabricating an appliance and an auxiliary in different orientations (e.g., top to bottom versus bottom to top) is an example of different manufacturing techniques herein that may result in geometries of the corresponding engaging surfaces that engage insufficiently, sub-optimally, or less than ideally to facilitate the desired treatment. Additionally, for example, fabricating an appliance and an auxiliary using different types of 3D printing processes is an example of different manufacturing techniques herein that may result in geometries of the corresponding engaging surfaces that engage insufficiently, sub-optimally, or less than ideally to facilitate the desired treatment. Additional examples of different types of manufacturing techniques for the auxiliary and the appliance are described herein.

One aspect of the disclosure herein is related to updating at least one surface of a 3D model of an auxiliary or an appliance to create an updated geometry so that the fabricated engaging surfaces will more closely conform with one another and thereby achieve better force systems to facilitate the orthodontic treatment. The disclosure herein may find application in updating a surface of an auxiliary, or in updating a surface of an appliance, such as a surface of an appliance that is designed to engage with a surface an auxiliary.

Auxiliaries described herein may include dental attachments, buttons, power arms, brackets, or any other fixture that is fixed to one or more teeth for engaging with a dental appliance (e.g., a clear aligner, a palatal expander, a mouth guard, a retainer) to facilitate an orthodontic treatment. While the auxiliaries in some examples described herein may comprise dental attachments, methods and systems herein may comprise other types of auxiliaries.

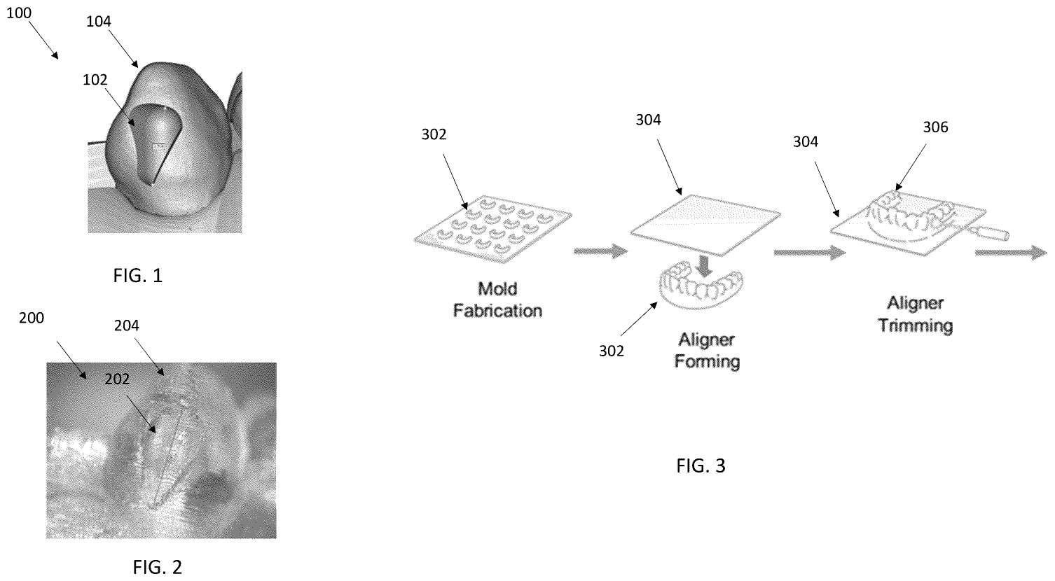

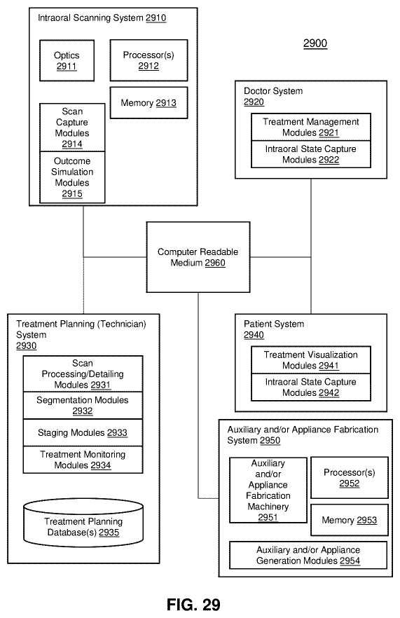

An orthodontic treatment may include generating or receiving a 3D model of a patient's dentition, which may comprise using intraoral scanning system 2910 in FIG. 29. The treatment may include determining geometries for auxiliaries that are to be fixed to one or more teeth to engage the appliance to apply force systems to facilitate the treatment, which may comprise using treatment planning system 2930 in FIG. 29. The treatment may include generating a 3D model of the dentition and auxiliaries, such as a CAD model. FIG. 1 illustrates a portion of exemplary 3D model 100 that includes tooth model 104 and auxiliary model 102 in a position and with a configuration designed to impart forces when engaged with an appliance. In this example auxiliary 102 is a tooth attachment adapted to engage with an attachment well of an appliance. The model may include a complete model of a patient's dentition and one or more auxiliaries (e.g., attachments).

The term “3D model” as used herein may refer to data configured to represent or render a 3D model, or may refer to the 3D model itself.

A common technique for manufacturing articles (e.g., appliances and auxiliaries for dental applications) involves additive manufacturing techniques such as 3D printing. As will be discussed in further detail herein, certain 3D printing methods (e.g., stereolithography (SLA), digital light processing (DLP), volumetric printing) that involve curing a material using an energy (e.g., light) may be prone to overcure due to, e.g., penetration of the energy (e.g., light) to regions beyond the intended target regions. That is, at least a portion of the energy may travel through the material farther than optimal, and may thus cure an additional region (referred to herein as an “overcure region”), causing a deviation in the fabricated article as compared to an initial 3D model on which the article was based. Such deviations can be especially problematic in the case of articles that are manufactured separately but are required to physically interact with each other, because a deviation in one or both articles may cause the interaction to be suboptimal.

Certain dental applications (e.g., orthodontics) require the use of separate articles that interact with each other. For example, certain dental treatments require the use of an appliance that is configured to physically engage with auxiliaries (e.g., attachments, power arms, buttons). In this example, one or more auxiliaries (e.g., attachments, buttons) may be fabricated and secured to a patient's teeth, and an appliance (e.g., an aligner, a palatal expander) may be fabricated to be placed over the patient's teeth and the one or more auxiliaries, where the appliance includes one or more corresponding receiving wells that fit over the one or more auxiliaries.

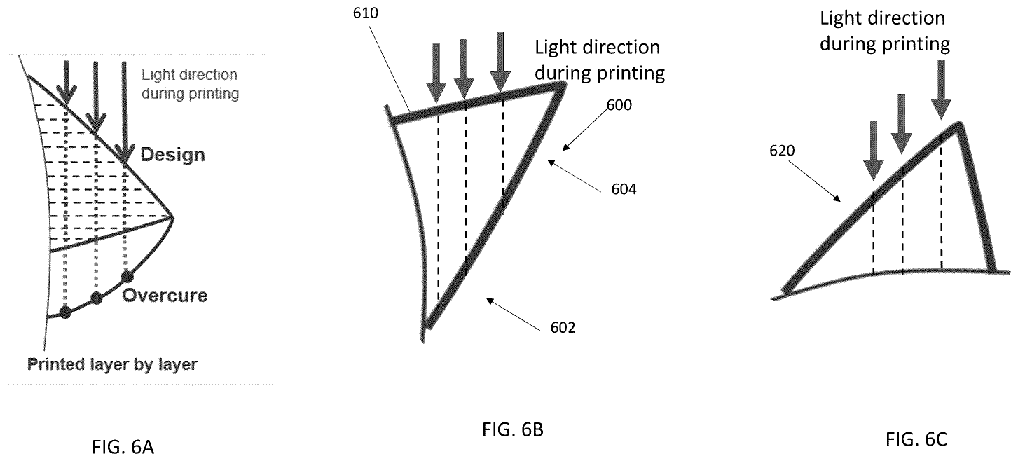

As will be explained in further detail below, in some cases, an appliance (or a physical mold for ultimately forming the appliance) may be fabricated in a first orientation while an auxiliary (or a mold for ultimately forming the auxiliary) is fabricated in a second orientation. For example, an appliance may be 3D printed such that its gingival portion is on the bottom and a corresponding auxiliary may be 3D printed such that its gingival portion is on the top. That is, one may be printed upside down, while the other may be printed right side up. This difference in manufacturing techniques may be necessary or at least optimal in many cases (e.g., the first fabrication method may be feasible for forming an appliance but not for forming auxiliaries). The overcure issue is particularly problematic in such cases, for example, because a receiving well of an appliance printed in a first orientation may include an overcure region in a first direction (e.g., in a gingival direction), while a corresponding auxiliary printed in a different orientation may not include a corresponding overcure region in that first direction. As such, there is a mismatch such that the auxiliary may not suitably conform to, and thus may not suitably engage with, its corresponding receiving well. This may result in suboptimal performance. In some cases, a mismatch may even result in the auxiliary not fitting within its corresponding receiving well, thus rendering the appliance or the auxiliary ineffective or unusable. This is illustrated and described in more detail herein, e.g., in reference to FIGS. 6A, 6B and 6C.

One aspect of the methods and systems disclosed herein are intended to address this issue by predicting overcure and/or other deviations that may result from the fabrication techniques, and adjusting the geometries of either or both of the 3D models of the appliance and the one or more auxiliaries to account for such deviations and thus make the appliance and the auxiliaries suitably conform to each other.

In some examples, dental appliances may be formed based on physical models (e.g., molds) corresponding to a patient's dentition and any existing or planned auxiliaries (e.g., attachments), wherein the physical models may be fabricated based on 3D model data. For example, the appliances may be thermoformed over the physical models or otherwise manufactured based on the physical models (e.g., injection molding). FIG. 2 illustrates an example of a portion of mold 200 created based on a 3D model of dentition and auxiliary that is adapted to engage with an appliance as part of an orthodontic treatment. Mold 200 includes tooth 204 and auxiliary 202, in this case a dental attachment.

FIG. 3 illustrates an exemplary process in which a plurality of molds (including the mold 302) have been fabricated. The plurality of molds may be fabricated at once using an additive manufacturing technique (e.g., 3D printing techniques such as stereolithography, digital light processing, powdered sintering, volumetric printing). A sheet of material 304 is thermoformed over the mold 302 to form a corresponding appliance 306. The appliance may be a dental appliance such as an aligner, a palatal expander, a retainer, a mouth guard, a sports guard, etc. The configuration of the thermoformed appliance, including auxiliary wells, depends on the shape of the mold. Appliances formed using a mold as an intermediary (rather than directly formed, e.g., by directly 3D printing a 3D model of an appliance) may be referred to herein as having been formed “indirectly.”

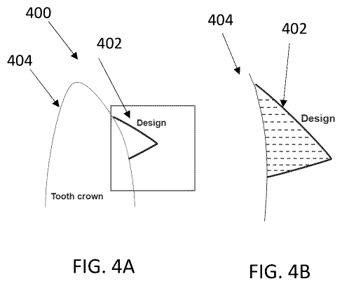

Molds 200 and 302 may be fabricated using a direct fabrication technique, such as printing layer by layer, and based on a 3D model that corresponds to a patient's dentition and planned/existing auxiliaries on such dentition, such as 3D model 100 in FIG. 1. FIGS. 4A and 4B represent model data 400, including a tooth representation 404 and an auxiliary representation 402. The auxiliary representation 402 in FIGS. 4A and 4B reflects an initial geometry that is designed for the patient (referred to herein as the “initial geometry”) based on a treatment plan and/or characteristics of the patient to bring about a particular result for the patient when the auxiliary is secured to the patient's tooth and made to engage the appliance that is to be ultimately fabricated. The dashed lines in FIG. 4B are included to illustrate that the mold in this example (which includes the auxiliary corresponding to auxiliary representation 402) is directly fabricated (e.g., photocured) layer by layer based on the 3D model data.

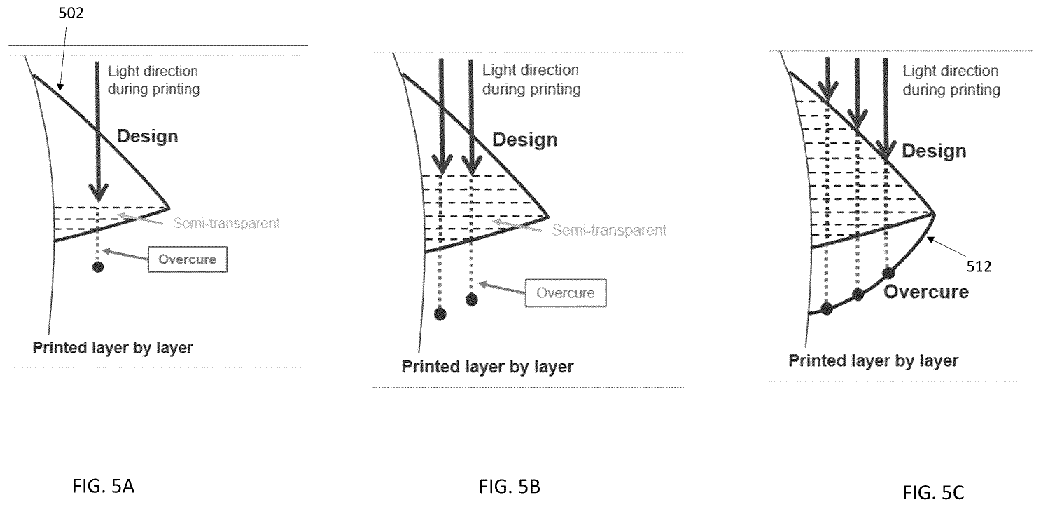

Molds may be printed layer by layer using, for example, stereolithography (SLA). FIGS. 5A-5C illustrate layer by layer 3D printing (photocuring) of designed auxiliary 502 from an initial 3D model of an auxiliary. As illustrated in these figures, the final fabricated geometry of the auxiliary is different, in this case larger, than the initial geometry of the designed auxiliary 502, due to overcuring. During SLA mold printing, the mold is printed layer by layer. When printing layers above, light energy passes through the printed parts and causes overcuring near the bottom surface, as shown in FIG. 5C. As illustrated in FIGS. 5B and 5C, the semi-transparent material allows some UV light to pass through and form an overcured region 512 near the bottom surface of the initial geometry that was designed for the patient. This overcured region 512 thus extends beyond that of the initial geometry of the initial 3D model 502 of the auxiliary and as a result may create issues or at least may not be optimal. During mold printing, in some cases, a printed auxiliary may be larger than the initial 3D model of the auxiliary (e.g., by about 0-500 μm) in one or more directions. As shown in FIG. 5C, the amount of overcure may vary along the length of the bottom surface. In some cases, other unintended deviations may occur (e.g., differences in shape). The mold therefore includes one or more auxiliaries that each have a geometry that is different than the geometry of the initial 3D model of the auxiliary. Although this disclosure focuses on methods to address changes in geometry stemming from overcuring, it contemplates that changes in geometry may stem from any other manufacturing process effects and similar methods may be used to address such changes.

When a dental appliance is formed (e.g., thermoformed) on the mold (e.g., the mold 302), such as is shown in FIG. 3, the dental appliance will be formed with one or more auxiliary wells that are configured to more closely conform to or match with the mold auxiliary shape rather than the initial geometry of the initial 3D model of the auxiliary.

In some cases, the mold (e.g., the mold 302) may also be used to form an auxiliary template (e.g., by thermoforming over the mold) that has one or more auxiliary wells that may then be subsequently used to form one or more corresponding auxiliaries on a patient's dentition. For example, the auxiliary template may be positioned over the patient's dentition and then a curable material may be flowed into the auxiliary wells and then cured on the patient's dentition. Similar to appliances formed using a mold, auxiliaries formed using a mold may be referred to herein as having been formed “indirectly.”

When an auxiliary template is thus indirectly formed on the same mold upon which the dental appliance is formed, the auxiliary template will have geometries that sufficiently conform to the auxiliary wells in the dental appliance since they are both indirectly formed on the same mold. That is, even if there were deviations in the mold (e.g., caused by overcuring as in FIGS. 5A-5C), if both the appliance and the auxiliary template are formed on that mold, the resulting auxiliary may conform sufficiently to the auxiliary engagement wells in the appliance such that there may not be a problem.

However, in some examples, rather than using the same fabrication technique to create the auxiliary, the dental auxiliaries described herein may be fabricated in an orientation that is different than the orientation in which the mold is printed. Different fabrication orientations herein refer to relative fabrication orientations between two objects that are at an angle greater than zero, such as 180° (opposite orientations), 90°, 45°, or 25°, or other angle. Different fabrication orientations may form an auxiliary with a geometry that is different than a receiving well of a dental appliance (e.g., an appliance that has been formed by thermoforming over a mold) since, in this example, the receiving well of the dental appliance is formed based on the mold shape of the auxiliary, which may include, e.g., the overcure region 512 as shown in FIG. 5C. Auxiliaries that are directly fabricated in a different orientation may have geometries that are different than the geometry of the well, and may be closer to the initial 3D model geometry as designed. As such, if there has been overcure or other deviation (e.g., in shape, volume, etc.) in the formation of a mold used to create a corresponding appliance, and the auxiliary is fabricated (e.g., 3D printed) in a different orientation, the auxiliary may have a geometry that is different from the receiving well, resulting in sub-optimal interaction between the two components. In one example, a dental appliance may be fabricated in a first orientation where the gingival side of a receiving well faces downward (e.g., using an indirect fabrication technique as described above, using a direct fabrication technique such as 3D printing, etc.), and an associated dental auxiliary may be fabricated in a second orientation (e.g., using an indirect fabrication technique as described above, using a direct fabrication technique such as 3D printing, etc.) where the gingival side of the dental auxiliary faces upward. In some examples, the dental appliance may be fabricated using an indirect fabrication technique and the dental auxiliary may be manufactured using a direct fabrication technique (and in different orientations).

FIG. 6A illustrates the orientation of printing a mold shown in FIGS. 5A-5C. FIG. 6B illustrates an exemplary different fabrication technique that includes a direction or orientation of printing that is different than the orientation in which the mold is formed. In this example, auxiliary 600 is fabricated top to bottom with top region 602 of the auxiliary being formed before bottom region 604. In this fabrication process, bottom region 604, including gingival surface 610, is not prone to overcuring as much as (if at all) the same region when the mold is printed in the orientation shown in FIG. 6A, with the gingival surface at the bottom. In this example, printed gingival surface 610 will have a shape that is closer to the gingival surface of the initial 3D model of the auxiliary than the molded shape. The printed auxiliary 600 in FIG. 6B, including the gingival surface 610, will not conform with the shape of the receiving well of the appliance that is formed on the mold, wherein the mold includes the overcured gingival region.

While the disclosure herein may give examples in which an appliance is indirectly formed (e.g., thermoformed) and one or more auxiliaries are directly formed (e.g., 3D printed), different fabrication techniques that may result in sub-optimal geometry conformity between surfaces may include directly fabricating both the appliance and the auxiliaries but at different angles or orientations. In this case, the different angles or orientations is an example of different fabrication techniques described herein. For example, FIGS. 6A and 6B illustrate opposite orientations of printing (180° difference). Orientations may be different at non-zero angles other than 180°, however, that will create a lack of sufficient conformity. For example, the difference illustrated between FIGS. 6A and 6C is a 90° difference (or about 90° difference) in orientation when printing auxiliary 620, and which will also create a lack of sufficient conformity between the well and the gingival surface of the 3D printed auxiliary 620 based on the initial 3D model of the auxiliary. Predicting the updated geometries herein adjusts the error surfaces of the initial 3D model of the auxiliary and creates updated surfaces that conform to the corresponding interfacing surface of the corresponding dental component.

In the example of an overcure as shown in FIG. 5C, a receiving well of an appliance formed using the mold may be larger than a corresponding auxiliary in one or more dimensions. Such difference in geometry may cause less contact between the appliance receiving well and the auxiliary, which may lead to a smaller and/or unwanted force systems, and thus a less than ideal orthodontic treatment. In another example, a deviation along one or more surfaces of the mold corresponding to the receiving well may cause the receiving well to be smaller than the directly fabricated auxiliary. In another example, one or more surfaces of the mold corresponding to the receiving well may have deviations in shape, slope, etc., and such deviations may not exist in the directly fabricated auxiliary. In these examples, engagement between the auxiliary and the appliance may similarly be suboptimal.

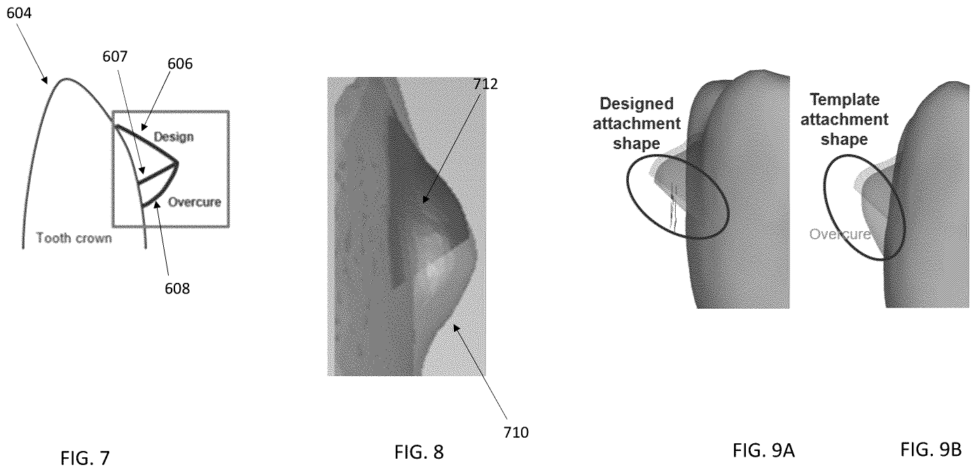

FIG. 7 illustrates tooth model 604, an initial geometry of an initial 3D model of an auxiliary as designed that includes surfaces 606 and 607, and a geometry of a predicted auxiliary that includes surfaces 606 and 608, where the predicted auxiliary is expected to be formed based on a mold with a deviation (e.g., including an overcure region) as described above. The molded auxiliary in FIG. 7 is larger than the initial 3D model due to the overcure region, with outer surfaces that define a larger volume than the volume defined by the geometry of the initial 3D model.

FIG. 8 shows an overlay of an initial 3D model of auxiliary 712, which in this case is an attachment, and a scan of a template attachment 710 thermoformed on an SLA mold. As shown, the geometry of initial 3D model 712 is different (in this case smaller) than the geometry of the template attachment 710, and the geometry of the template attachment 710 defines a larger volume than is defined by the volume of the geometry of initial 3D model 712.

FIGS. 9A and 9B illustrate additional examples of an initial 3D model design geometry for an auxiliary (FIG. 9A), and a predicted geometry adjusting for deviations due to, e.g., overcure (FIG. 9B). FIGS. 9A and 9B illustrate the difference in geometries, with the template attachment shape larger because it was formed using a mold that included an overcure region.

One aspect of the disclosure herein is related to adjusting at least one surface of a 3D model of an auxiliary or a 3D model of a corresponding appliance to create an updated geometry (e.g., by predicting deviations as described above and then adjusting surfaces on the initial 3D model based on the predicted deviations to generate an updated or adjusted 3D model), especially in the case where the auxiliary and the appliance are fabricated differently (e.g., in different orientations) such that there is a mismatch between the two. By adjusting the 3D model, the predicted overcure/deviation can be accounted for and the appliance and the corresponding auxiliary that are ultimately fabricated will more closely conform with one another and thereby achieve better force systems to facilitate the orthodontic treatment. The disclosure herein may find application in correcting a surface of a 3D model of an auxiliary to conform to a surface of an appliance (e.g., receiving wells of the appliance that are configured to engage with the surfaces of the auxiliary), or in correcting a surface of a 3D model of an appliance to conform to a surface of an auxiliary.

One of the technical solutions provided by the methods and systems herein is achieving desired force systems while allowing more flexibility in fabrication options for making dental components that work together (e.g., dental appliances and corresponding dental auxiliaries). For example, it may be more feasible or more optimal to print an appliance or a mold in a first orientation (e.g., with the gingival portion facing down) and more feasible or optimal to print an auxiliary in a second orientation (e.g., with the gingival portion facing up). As another example, it may be more feasible or optimal to fabricate an appliance indirectly (e.g., thermoforming over a mold that may have been formed by 3D printing), and more feasible or optimal to fabricate an auxiliary directly (e.g., direct 3D printing, for example, with DLP), or vice versa. As another example, it may be more feasible or optimal to fabricate an appliance (or a mold for forming the appliance) using a first 3D printing technique (e.g., SLA) and more feasible or optimal to fabricate an auxiliary (or a mold for forming an auxiliary template) using a second 3D printing technique (e.g., DLP). By adjusting 3D model geometries to account for mismatches between the appliance and the auxiliary resulting from the use of the different manufacturing techniques, compatibility may be achieved for these different techniques to enable an optimal combination of manufacturing techniques.

One aspect of this disclosure is a method of directly forming a dental auxiliary (e.g., attachment) that accounts for a difference between the geometry of a 3D model of the dental auxiliary and the geometry of an indirectly formed auxiliary well of the dental appliance that will engage with the dental auxiliary when the dental auxiliary is fixed to a tooth and the dental appliance is worn by a patient. The method includes predicting an updated geometry of an initial 3D model to conform to the geometry of an appliance auxiliary well to achieve better force systems based on the orthodontic treatment.

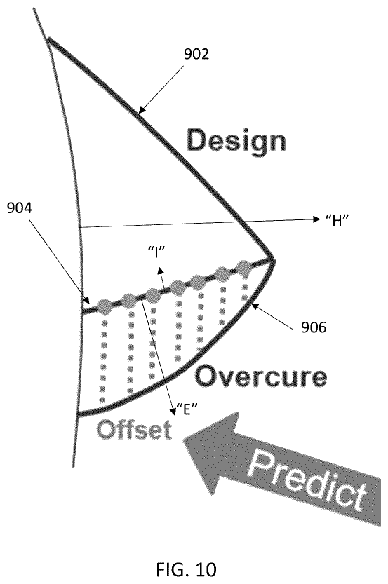

FIG. 10 illustrates a portion of a prediction process that includes adjusting the geometry of an initial 3D model of the auxiliary, represented by surfaces 902 and 904. The process adjusts the geometry of the initial 3D model to create an updated geometry that includes surfaces 902 and 906. In this example, error surface 904 is adjusted to create updated surface 906, which compensates for an overcured region of the mold auxiliary as described above. Adjusting the geometry to include updated surface 906 creates an auxiliary updated geometry that more closely conforms to the geometry of an auxiliary well of a dental appliance than the geometry of the initial 3D model of the auxiliary since the appliance, including the auxiliary well, is, in this example, indirectly formed on a mold.

In some embodiments, the 3D model of the appliance receiving well or of the auxiliary may be adjusted to have an updated geometry that actively uses a predicted overcure to form a desired shape. That is, a controlled amount of overcure may be used to fabricate a desired appliance or auxiliary. For example, referencing FIG. 10, rather than allowing for the formation of the overcure region (i.e., the portion between the surfaces 904 and 906), the 3D model of the auxiliary may be adjusted by adjusting the surface 904 of the 3D model to have a geometry that relies on overcure to ultimately fabricate an auxiliary that resembles the geometry of the initial 3D model. For example, this may involve “intruding” (i.e., bringing up in the direction “I” shown in FIG. 10) at least a portion of the surface 904 of the initial 3D model, and/or otherwise the shape of the surface 904. The methods and systems disclosed herein can be used to predict the dimensions of the overcure and the surface 904 can be adjusted accordingly in an updated 3D model such that when the auxiliary is actually printed, the result is an auxiliary that conforms to the initial 3D model (due to the controlled overcure). A similar method of controlled overcure may be used to fabricate an appliance.

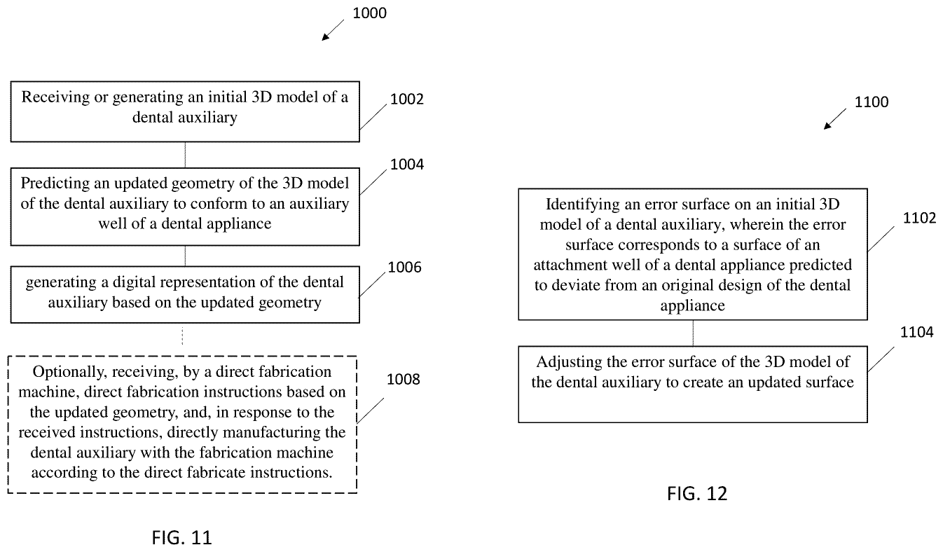

FIG. 11 illustrates an exemplary method of forming a dental auxiliary, which may occur at least in part in treatment planning system 2930 in FIG. 29. Method 1000 includes, at step 1002, receiving or generating an initial 3D model of a dental auxiliary. An initial 3D model of a dental auxiliary includes data configured to represent or render a 3D model. The initial 3D model may be generated in treatment planning system 2930 in FIG. 29, and based on an oral scan generated using intraoral scanning system 2910 in FIG. 29. FIG. 1 illustrates a portion of an initial 3D model of a dental auxiliary.

Method 1000 includes, at step 1004, includes predicting an updated geometry of the 3D model of the dental auxiliary to conform to an auxiliary well of a dental appliance. An updated geometry as described herein includes any type of adjustment made to the geometry of the initial 3D model. An updated geometry, an example of which is represented by surfaces 902 and 906 in FIG. 10, conforms to the appliance auxiliary well since, in that example, the appliance was indirectly formed on a mold (e.g., thermoformed), and thereby creates better force systems as part of the orthodontic treatment plan when the auxiliary is fixed to a tooth and the appliance is worn by the patient. Method 1000 includes, at step 1006, generating a digital representation of the dental auxiliary based on the updated geometry, which may occur in treatment planning system 2930 in FIG. 29. Method 1000 also optionally includes, at step 1008 receiving, by a direct fabrication machine, direct fabrication instructions based on the updated geometry, and, in response to the received instructions, directly manufacturing the dental auxiliary with the fabrication machine according to the direct fabricate instructions, which may occur in auxiliary and/or appliance fabrication system 2950 in FIG. 29.

FIG. 12 illustrates an exemplary method 1100 of predicting an updated geometry of the dental auxiliary from step 1004 in FIG. 11. Method 1100 includes, at step 1102, identifying an error surface on the initial 3D model of the dental auxiliary, such as error surface 904 in FIG. 10, wherein the error surface corresponds to a surface of the attachment well predicted to deviate from an original design of the dental appliance. The surface of the attachment well that is predicted from an original design may be due to a deviation that occurs based on a fabrication process. For example, as described herein, the predicted deviation may occur as a result of a fabrication technique that includes printing (e.g., layer by layer) a physical model of a patient's dentition, such as any of the molds herein. As described above, the deviation may be the result of overcuring in a portion of the auxiliary portion of the mold during the 3D printing, an example of which is shown in FIG. 5A-5C.

Method 1100 further comprises, at step 1104, modifying the error surface of the 3D model of the dental auxiliary to create an updated surface, an example of which is updated surface 906 shown in FIG. 10. Adjusting the error surface, as described herein, refers to any type of adjustment to the error surface. Similarly, an updated surface as described herein refers to a surface with any type of adjustment compared to and relative to the error surface.

Adjusting the error surface as described herein includes varying a shape, contour, volume, and/or geometry of the error surface, which are not necessarily exclusive properties of a surface as used herein. For example, there may be similarities in the properties of a shape, a contour, and a geometry of a surface. Varying a geometry of an error surface of an initial model (of an auxiliary or appliance) may refer to any adjustment to the geometry, shape, and/or contour of the error surface. For example, varying a geometry of the error surface may include adjusting the geometry of one or more portions of the error surface without adjusting the geometry of one or more other portions of the error surface. Additionally, for example, varying a geometry of the error surface may include adjusting a first portion of the surface to a greater extent than a second portion, examples of which are shown and described herein.

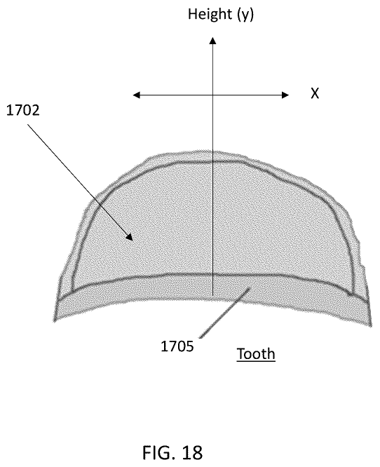

In some implementations, adjusting the error surface includes extruding at least a portion of the error surface outward in a direction normal to at least a portion of the error surface. For example, FIG. 10 illustrates adjusting error surface 904 that comprises extruding error surface 904 outward in a direction E that is normal to error surface 904. Extruding at least a portion of the error surface in the “E” direction does not require that all points on the surface are adjusted or moved by the same distance in a direction (e.g., along a long axis of an auxiliary). As shown in FIG. 10, for example, error surface 904 is adjusted in direction E to a greater extent generally in a region closer to the tooth surface than in a region further away from the tooth surface (relative to the “H” direction normal to the tooth surface, as shown, and referenced in FIG. 18).

In some implementations, adjusting the error surface may include intruding at least a portion of the error surface inward in a direction normal to at least a portion of the error surface. For example, FIG. 10 illustrates a direction of intrusion “I” that is normal to error surface 904.

In some implementations, the updated geometry may define a larger volume than a volume defined by the initial 3D model of the dental auxiliary. For example, as shown in FIG. 10, the updated geometry comprises surfaces 902 and 906 and defines a larger volume than the volume defined by the geometry of the initial 3D model, which includes surface 902 and error surface 904. In other implementations, the volumes of the initial geometry and the updated geometries may be the same after adjusting the error surface to the updated surface.

Methods of forming a dental auxiliary described herein may include predicting an updated geometry of the 3D model of the dental auxiliary to conform to an attachment well of a dental appliance. Updated geometries that conform to an attachment well are geometries that more closely conform to, or match, the geometry of the corresponding auxiliary well of the dental appliance compared with the geometry of the initial 3D model of the dental auxiliary. In this example, the term conform includes corresponding auxiliary and well surfaces that are more similarly configured to one another, or match, than corresponding initial auxiliary 3D model and well surfaces.

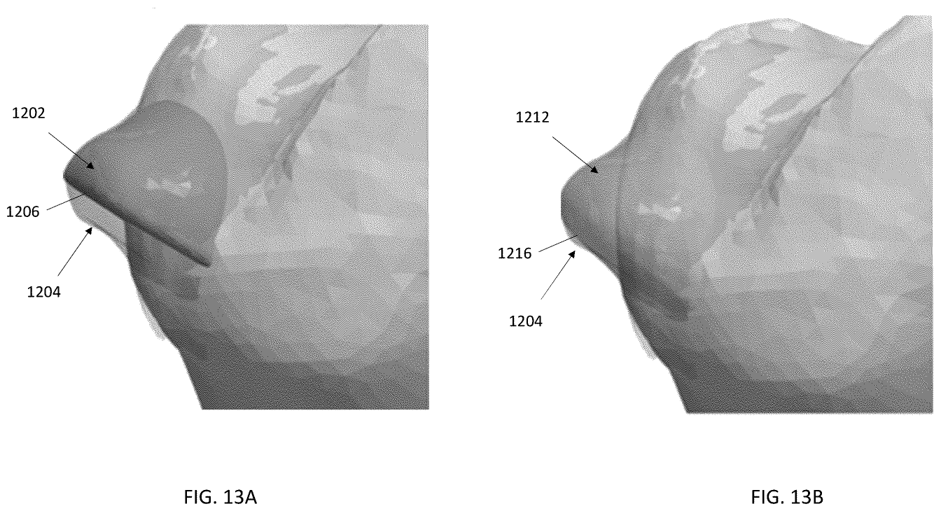

FIGS. 13A and 13B illustrate predicting an updated geometry of an initial 3D model of a dental auxiliary 1202 to conform to an auxiliary well of a dental appliance 1204.

FIG. 13A illustrates an initial 3D model of an auxiliary 1202 including error surface 1206, and dental appliance auxiliary well 1204. FIG. 13B illustrates a predicted updated geometry 1212 of the initial 3D model of the auxiliary 1202, wherein error surface 1206 has been adjusted to create updated surface 1216, wherein the updated geometry conforms to the auxiliary well 1204 of the dental appliance better than the initial 3D model of the auxiliary, as shown in FIGS. 13A and 13B.

Methods herein that are adapted to predict an updated geometry of an initial 3D model of a dental auxiliary may include trained models (algorithms) that are trained machine learning algorithms (learning algorithms). Trained models may be described herein as prediction models (“PM”), and specifically are overcure prediction models (“OPM”) if the trained model is adapted to predict an updated geometry of the auxiliary (or an appliance as described below) that compensates for overcuring (e.g., in a physical model) of the auxiliary during a physical model fabrication process.

One aspect of this disclosure is related to methods of training machine learning models such that the model, once trained, is adapted to receive as input a new or initial 3D model of a dental auxiliary and predict an updated geometry of the initial 3D model of the dental auxiliary to conform to an auxiliary well of a dental appliance.

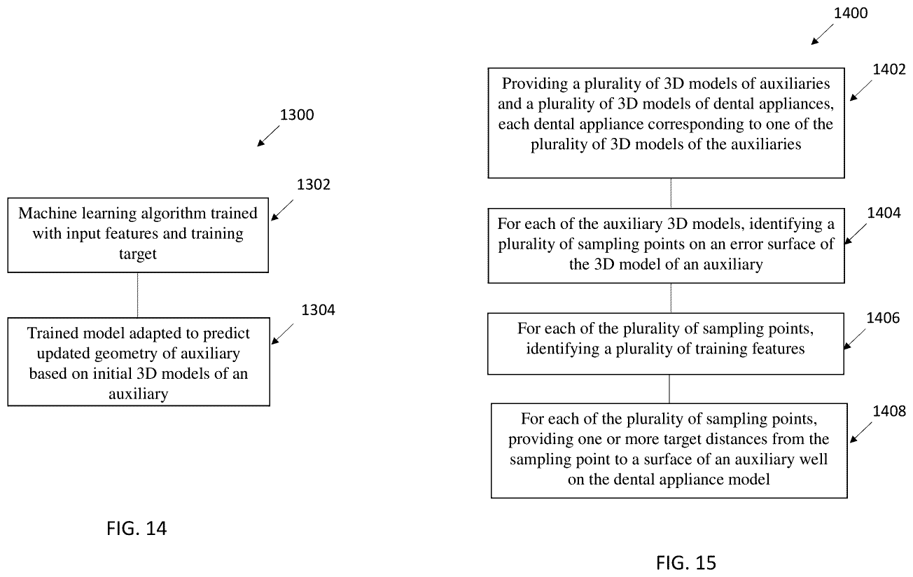

FIG. 14 illustrates an exemplary method 1300 of training a machine learning (“ML”) algorithm to create a trained model that, once trained, is adapted to predict an updated geometry of a 3D model of the dental auxiliary to conform to an attachment well of a dental appliance. Method 1300 includes, at step 1302, training an ML algorithm with input features and training targets. Once trained, at step 1304, the trained model is adapted to predict an updated geometry of an initial 3D model of an auxiliary.

Training models may include providing input features that comprise an initial 3D model of an auxiliary, and a 3D model of a dental appliance that has been indirectly fabricated on a physical model of dentition (e.g., mold) that was 3D printed based on the initial 3D model of the auxiliary. In this example, the appliance well has a geometry that does not conform to the geometry of the initial 3D model of the auxiliary because the appliance is indirectly formed on a mold that comprised an overcured auxiliary region. Machine learning algorithms can be trained with inputs of the initial 3D model of the auxiliary and 3D model data (e.g., scans) of indirectly fabricated dental appliances. The trained model, once trained, is adapted to receive an initial 3D model of an auxiliary and predict an updated geometry of the 3D model of the auxiliary to conform to an auxiliary well of a dental appliance. The trained model can thus predict an updated geometry that will provide better force systems as part of the orthodontic treatment.

FIG. 15 illustrates an exemplary method 1400 of training an ML algorithm to create a trained model that is adapted to, once trained, predict an updated geometry of an initial 3D model of a dental auxiliary to conform to an attachment well of a dental appliance. Method 1400 includes, at step 1402, providing a plurality of 3D models of auxiliaries and a plurality of 3D models of indirectly formed dental appliances, each dental appliance corresponding to one of the plurality of initial 3D models of the auxiliaries. For example, step 1402 may comprise providing a 3D model of an auxiliary 1202 from FIG. 13 and corresponding 3D model of dental appliance 1204.

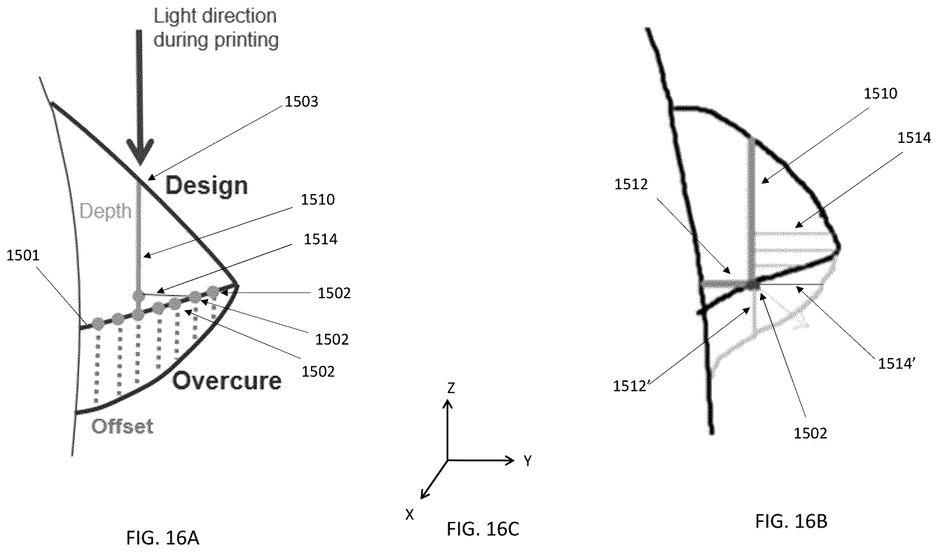

Method 1400 includes, at step 1404, for each of the auxiliary 3D models, identifying a plurality of sampling points on an error surface of the 3D model of an auxiliary. For example, FIGS. 16A and 16B illustrate a plurality of sampling points 1502 (only three are labeled for clarity) on error surface 1501.

Method 1400 includes, at step 1406, for each of the plurality of sampling points, identifying a plurality of training features for the sampling point. Training features as described herein may include one or more measurements from the sampling point, which may include measurements relative to points on the initial 3D model. Training features may include, for example, dimensions measured from each the sampling points to other locations in one or more directions. Exemplary training features include measurements calculated in the z-direction (reference axes shown in FIG. 16C and included in FIG. 18), represented as distance 1510 in FIGS. 16A and 16B, dimensions in the x-direction (into and out of the page in FIGS. 16A and 16B), dimensions in the y direction such as surface normal measurements shown as distance 1514 in FIGS. 16A and 16B, and distance to tooth, shown as distance 1512 in FIG. 16B. Other training features may also be used to train, and not all training features described herein necessarily need to be used to train a particular model, depending on the particular application of the implemented method. The “z” direction as used herein refers to a direction along a longitudinal axis of the dental auxiliary (as represented in FIGS. 16A, 16B and 16C), which corresponds to a longitudinal axis of a tooth to which the dental auxiliary is configured to be bonded.

Method 1400 also includes, at step 1408, for each sampling point, providing one or more target distances from the sampling point to a surface of the auxiliary well of the 3D model of the dental appliance, while in other methods the target distances may be measured from the sampling points to a surface on a 3D model (e.g., from a scan) of an indirectly formed (e.g., thermoformed) attachment template. The target distances may include some or all of the training feature dimensions. FIG. 16B illustrates exemplary target distances that include depth in z direction 1512′ (which in this example is along a long axis of the auxiliary) and surface normal measurement 1514′, measured from each of the sampling points to surfaces of the auxiliary well surface. Only one sampling point is identified in FIG. 16B, but training methods generally include many points, such as hundreds of sampling points (e.g., between 200 and 500 sampling points).

Method 1400 creates a trained model with parameters that can, upon receipt of an initial 3D model of a dental auxiliary, predict an updated geometry of the initial 3D model of a dental auxiliary to conform to an auxiliary well of the dental appliance.

Any of the machine learning models herein may be supervised models that are provided with one or more inputs and targets, examples of which are provided herein.

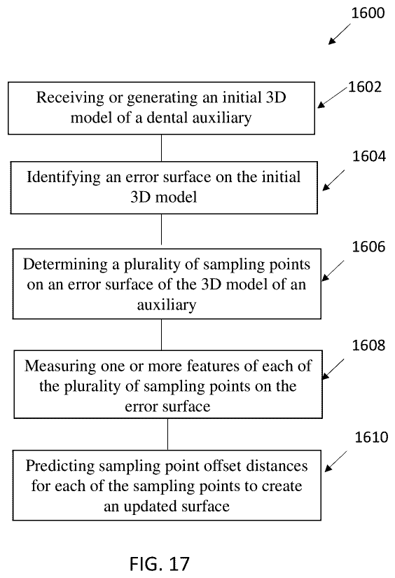

FIG. 17 illustrates an exemplary method 1600 performed by a trained model (and which may be implemented with one or more processors), such as a model trained according to method 1400 in FIG. 15. Method 1600 is a method of predicting an updated geometry of the initial 3D model of the dental auxiliary to conform to an attachment well of a dental appliance, and is an example of a particular implementation of the prediction method 1100 in FIG. 12. Method 1600 includes, at step 1602, receiving or generating an initial 3D model of a dental auxiliary, such as a CAD file including a dental attachment. Method 1600 includes, at step 1604, identifying an error surface on the initial 3D model 1503, such as error surface 904 in FIG. 10, error surface 1206 in FIG. 13A, or error surface 1501 in FIG. 16A. Method 1600 includes, at step 1606, determining a plurality of sampling points on the error surface, such as sampling points 1502 shown in FIG. 16A. Prediction method 1600 includes, at step 1608, measuring one or more features of each of the plurality of sampling points on the error surface, such as any of the feature dimension described herein (e.g., measurement in z-direction, measurement in x-direction, measurement in y-direction, surface normal measurement, distance to tooth).

Prediction method 1600 further includes, at step 1610, based on the measured features of sampling points on the error surface of the new 3D model of the auxiliary, predicting offset dimensions for the sampling points, and thereby creating an updated surface of the new 3D model. The updated surface may be predictive of an indirectly formed template attachment and indirectly formed auxiliary well configuration. The updated geometry of the 3D model of the dental auxiliary, including the updated surface, facilitate better force systems for the dental appliance and auxiliary based on the orthodontic treatment plan.

The prediction methods herein provide an estimation or prediction of the geometry of an actual appliance auxiliary well or other dental component. This can allow more options for fabricating one or more dental components while compensating for geometrical differences and achieve better force systems based on the orthodontic treatment.

Methods of predicting an updated auxiliary geometry herein may optionally further comprise predicting a variable geometry of the auxiliary, which may also be referred to herein as flash, a flash geometry, a flash layer, or composite layer, or similar derivative thereof. During bonding, doctors/technicians follow standard orthodontic practices which involves preparation of the enamel surface (e.g. cleaning, polishing, and/or etching) and the application of a bonding agent (e.g. primer, resin, and/or adhesive) in order to adhere the dental auxiliary to the tooth. This tends to result in a build-up of material between the tooth and dental auxiliary (both in the normal direction of tooth surface (referred to as the y direction in FIG. 18) as well as in the x direction of the tooth surface, labeled in FIG. 18) than the original design plan. FIG. 18 illustrate auxiliary 1702, in this example a tooth attachment, and composite 1705 between the tooth and the auxiliary, which builds-up the amount of material upon the tooth surface. Predicting a geometry of this flash layer 1705, including the height dimension y of the flash layer in the direction normal to the tooth surface 1705, allows the updated auxiliary geometry to account for the composite or flash and modify the auxiliary geometry to compensate for the height of the composite.

Methods of predicting auxiliary updated geometry that also predict a flash geometry may be trained models that are trained with input features that include flash features. For example, scans may be generated or received of dental appliances that include a flash geometry. The inputs to the machine learning model may include a plurality of 3D models of auxiliaries, and a plurality of 3D models of the flash geometry. The target may include the distance the auxiliary is away from the tooth in the positive dimension, which may be considered to allow the auxiliary to compensate for the composite layer.

Additionally, indirect fabrication processes (e.g., thermoforming) may cause the indirectly formed dental appliance to have a geometry that does not precisely conform to the physical model of the dentition (e.g., SLA mold). For example, during thermoforming, a polymer sheet may not fully wrap around or exactly conform to the physical model (e.g., SLA mold), which may cause gaps near the geometry intersections, observed as rounding fillet. Methods of predicting an updated geometry of the 3D model of the dental auxiliary described herein may include global rounding to mimic the thermoforming errors of the appliance. Different materials have different thermoforming ability (such as EX15 and ST30), and methods of predicting herein can modify one or more rounding radii to accommodate different materials.

Methods of predicting updated geometries described herein may also include predicting added or additional rounding to one or more surfaces of the initial 3D model due to fabrication errors in a fabrication process in which the dental appliance does not fully wrap on or exactly conform to a physical model (e.g., mold) of a dentition. The fabrication errors may be based on a difference in material between a physical model of dentition and a material of the dental appliance being formed thereon.

Methods of predicting auxiliary updated geometry that also predict added rounding to the auxiliary can be trained models that are trained to predict the added rounding in response to receiving an initial 3D model of an auxiliary.

The methods of predicting an updated geometry of an initial 3D model of a dental auxiliary as described herein may thus modify an error surface that corresponds to a surface of a well predicted to deviate from an original design of the appliance, account for in an increase in positive dimension related to flash geometry, and/or additional rounding due to the fabrication of the dental appliance, resulting in better force system based on the orthodontic treatment.

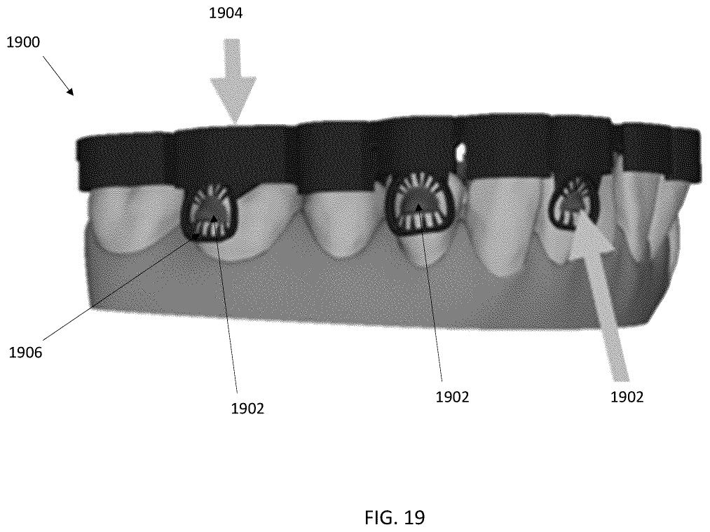

Methods described herein may include, in response to received instructions to directly manufacture the dental auxiliary based on the updated geometry, directly fabricating the dental auxiliary, which may occur in auxiliary and/or appliance fabrication system 2950 in FIG. 29. Fabricating the auxiliary may include directly fabricating a removable template integrally formed with the dental auxiliary. FIG. 19 illustrates an exemplary directly fabricated device 1900 that includes a plurality of attachments 1902 integrally formed with a template or positioner 1904. Device 1900 further includes detachable components 1906 that facilitate easy removal from attachments 1902 so that template 1904 and components 1906 can be removed once the attachments are fixed to the teeth with a composite material.

Attachments 1902 in FIG. 19 are shown generally to have similar or the same geometries, but attachments 1902 may alternatively have other planned geometries based on the orthodontic treatment. Device 1900 in FIG. 19 may include one or more attachments, including optionally an attachment associated with every tooth.

Methods of fabricating the one or more auxiliaries may include directly fabricating the dental auxiliary without directly fabricating an integral supporting structure coupled to the directly formed dental auxiliary. For example, attachments 1902 shown in FIG. 19 may be directly manufactured alone, without template 1904 or components 1906.

Direct fabrication techniques described herein may include a layer by layer manufacturing technique, optionally 3D printing.

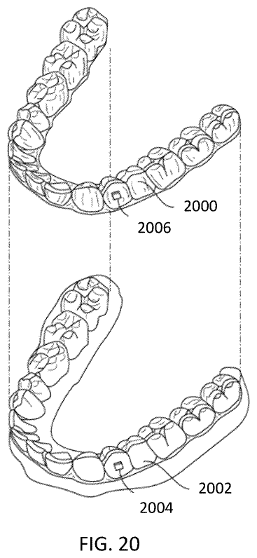

FIG. 20 illustrates a representative dental appliance that can be worn on teeth as part of any of the orthodontic treatment plans herein. In some examples, the dental appliance can include a shell (e.g., a continuous polymeric shell or a segmented shell) having teeth-receiving cavities that receive and optionally also resiliently reposition the teeth. A dental appliance or portion(s) thereof may be indirectly fabricated using a physical model of teeth, such as a mold. For example, a dental appliance (e.g., polymeric appliance) can be formed using a physical model of teeth and a sheet of suitable layers of polymeric material. In some embodiments, a physical appliance is directly fabricated, e.g., using additive manufacturing techniques (e.g., layer by layer), from a digital model of an appliance. A dental appliance can fit over all teeth present, or less than all of the teeth. The dental appliance can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the dental appliance can be a generic appliance configured to receive the teeth, but not necessarily shaped to match the topography of the patient's teeth. In some cases, only certain (or none) of the teeth received by a dental appliance will be repositioned by the appliance while other teeth can provide a base or anchor region for holding the appliance in place as it applies force against the tooth or teeth targeted for repositioning. In some cases, none of the teeth will be repositioned at some point during the correction treatment. Teeth that are moved can also serve as a base or anchor for holding the appliance as it is worn by the patient. Typically, no wires or other means will be provided for holding an appliance in place over the teeth. In some cases, however, it may be desirable or necessary to provide individual attachments or other anchoring elements or auxiliaries 2004 on teeth 2002 with corresponding receptacles, wells or apertures 2006 in the dental appliance so that the appliance can apply a selected force on the tooth. Exemplary appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

Auxiliary 2004 is an example of an auxiliary for which methods herein may predict an updated geometry to conform to a dental appliance, and which may be directly manufactured according to methods of fabrication herein.

Appliance 2000 can include auxiliary components (e.g., features, accessories, structures, devices, components, and the like). Examples of such accessories include but are not limited to arch expanders, palatal expanders, twin blocks, occlusal blocks, bite ramps, mandibular advancement splints, bite plates, pontics, hooks, brackets, headgear tubes, springs, bumper tubes, palatal bars, frameworks, pin-and-tube apparatuses, buccal shields, buccinator bows, wire shields, lingual flanges and pads, lip pads or bumpers, protrusions, divots, and the like.

While some methods herein describe predicting an updated geometry of a 3D model of a dental auxiliary to conform to an auxiliary well of a dental appliance (such as if the dental appliance is indirectly manufactured (or if the auxiliary and appliance are fabricated using any of the exemplary different manufacturing techniques described herein), the disclosure is also related to methods of predicting an updated geometry of a 3D model of a dental appliance to conform to a geometry of a dental auxiliary. For example, dental appliances may be directly manufactured while one or more auxiliaries may be indirectly manufactured, such as incorporated with a template attachment formed upon a physical mold as described above, including with reference to FIGS. 1-8B. For example, template attachments may be indirectly formed on an SLA mold that has been 3D printed and that include one or more attachments with overcured regions, described above. Direct fabrication techniques used to fabricate an appliance may fabricate an auxiliary well of the appliance that has a geometry that does not conform or match with a corresponding dental auxiliary since the dental auxiliary is formed based on the mold shape of the auxiliary that includes the overcure region, as example of which is shown in FIG. 5C. The prediction concepts herein are thus equally applicable to predicting an updated geometry of an initial 3D model of an auxiliary well of a dental appliance to conform to a dental auxiliary (or other surface of an appliance as may be needed based on the application).

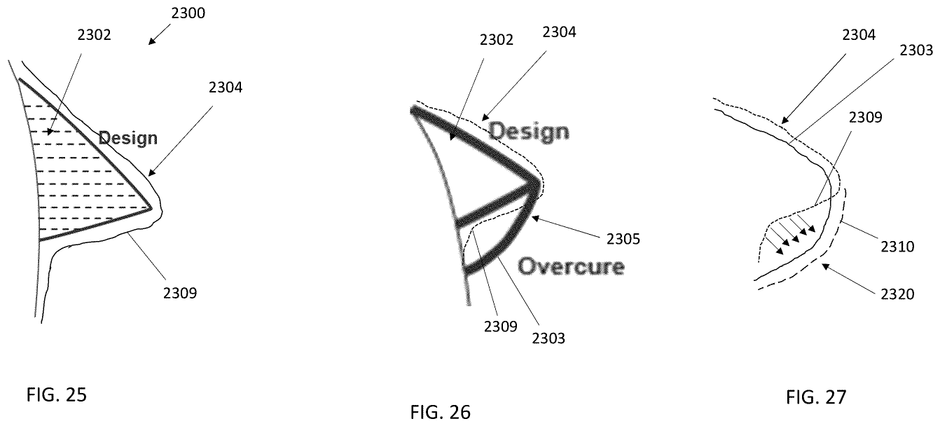

Method 2100 is an exemplary method of forming a dental appliance, which may occur at least in part in treatment planning system 2930 in FIG. 29. Method 2100 includes, at step 2102, receiving or generating an initial 3D model of a dental appliance, wherein an example of a portion of an initial 3D model of a dental appliance is represented as model 2304 in FIG. 25. An initial 3D model includes data configured to represent or render a 3D model, and may be generated in treatment planning system 2930 in FIG. 29 and based in part on an oral scan generated using intraoral scanning system 2910 in FIG. 29.

Method 2100 includes, at step 2104, predicting an updated geometry of the 3D model of the dental appliance to conform to a dental auxiliary. An updated geometry as described herein includes any type of adjustment to the initial 3D model, which is described in more detail herein relate to predicting an updated geometry of an initial 3D model of an auxiliary. FIG. 27 illustrates an exemplary predicted updated geometry 2320 of the initial 3D model of the dental appliance, wherein the updated geometry 2320 includes updated surface 2310, which is predicted to conform to geometry 2303 of the dental auxiliary, which in this example includes an overcured region 2305 (labeled in FIG. 26), described in more detail herein. FIG. 27 illustrates error surface 2309 of the initial 3D model of the appliance, which in this example is updated to create updated surface 2310. FIG. 27 also shows a plurality of parallel arrows illustrating a general direction of extrusion in which error surface 2309 is adjusted to create updated surface 2310 of updated geometry 2320. The updated geometry more closely conforms to the auxiliary geometry since the auxiliary may be indirectly formed on a physical model of the dentition (e.g., thermoformed), thus creating a better force system between appliance and auxiliary as part of the orthodontic treatment when the auxiliary is fixed to a tooth and the directly manufactured appliance is worn over the teeth of the patient.

Method 2100 includes, at step 2106, generating a digital representation of the dental appliance based on the updated geometry, which may occur in treatment planning system 2930 in FIG. 29. Method 2100 also optionally includes, at step 2108, receiving, by a direct fabrication machine, direct fabrication instructions based on the updated geometry, and, in response to the received instructions, directly manufacturing the dental appliance with the fabrication machine according to the direct fabrication instructions, which may occur in auxiliary and/or appliance fabrication system 2950 in FIG. 29.

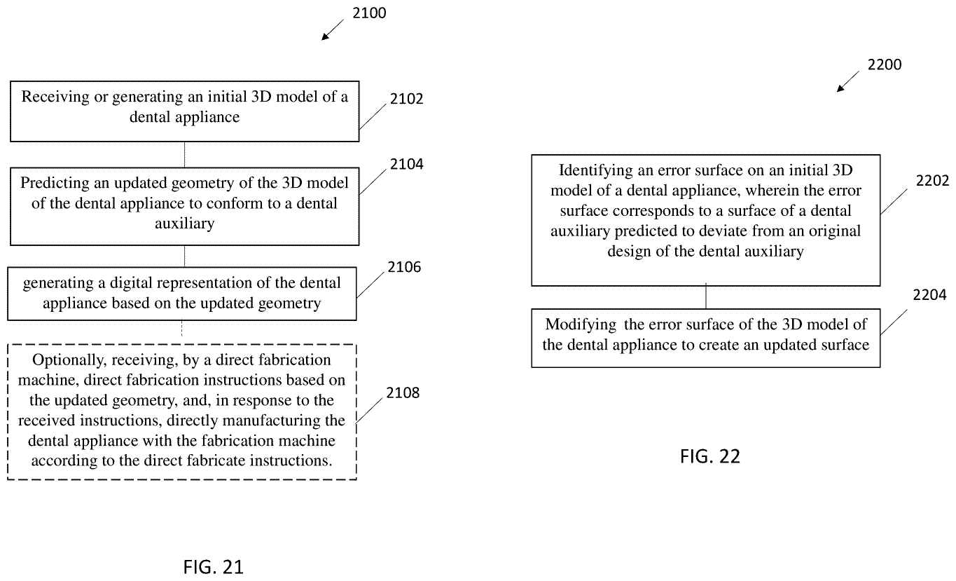

FIG. 22 illustrates an exemplary method 2200 of predicting an updated geometry from step 2104 in FIG. 21. Method 2200 includes, at step 2202, identifying an error surface on the initial 3D model of the dental appliance, such as error surface 2309 in FIGS. 25-27, wherein the error surface corresponds to a surface of the auxiliary predicted to deviate from an original design 2302 of the dental auxiliary. The surface of the auxiliary that is predicted to deviate from an original design may be due to a deviation that occurs due to a difference in fabrication techniques, several examples of which are provided herein. For example, as descried herein, the predicted deviation may occur as a result of a fabrication process that includes 3D printing a physical model of a patient's dentition, such as any of the molds herein. As described above, the deviation may be the result of overcuring during the 3D printing, an example of which is shown in FIGS. 5A-5C, and in FIG. 26.

Method 2200 further comprises, at step 2204, modifying the error surface of the 3D model of the dental appliance to create an updated surface, an example of which is updated surface 2310 shown in FIG. 27. Modifying the error surface, as described herein, refers to any type of adjustment to the error surface, including one or more of shape, contour, or geometry, and which may or may not result in a change in volume. Similarly, an updated surface as described herein refers to a surface with any type of adjustment, modification, or variation as compared to the error surface.

Adjusting the error surface as described herein includes modifying some aspect of the error surface in at least one dimension. Adjusting a geometry of the error surface refers to any adjustment to the geometry of the error surface. For example, adjusting a geometry of the error surface may include modifying the geometry of one or more portions of the error surface, but not modifying the geometry of one or more other portions of the error surface, or modifying a first portion to a greater extent than a second portion.

In some implementations, adjusting the error surface includes extruding at least a portion of the error surface outward, optionally in a direction normal to at least a portion of the error surface. For example, FIG. 27 illustrates modifying error surface 2309 by extruding error surface 2309 outward in a direction E. Extruding at least a portion of the error surface in the “E” direction does not require that all points on the surface are modified or moved by the same distance. As shown in FIG. 27, for example, some portions of error surface 2309 are adjusted in direction E to a greater extent than other portions of error surface 2309. For example, a more centrally located region of error surface 2309 may be adjusted further than more laterally disposed portions of error surface 2309.

In some implementations, adjusting the error surface may include intruding at least a portion of the error surface inward in a direction normal to at least a portion of the error surface, or adjusting may include any necessary adjustment to create optimal engagement between interfacing surfaces of the dental devices.

In some implementations, the updated geometry of the auxiliary well of the appliance defines a larger volume than a volume defined by the initial 3D model of the auxiliary well, while in other implementations the volume may be less or the same. For example, as shown in FIG. 27, the updated geometry 2320 of appliance well defines a larger volume than the volume defined by the geometry of the 3D model of the appliance well.

Methods of forming a dental appliance described herein may include predicting an updated geometry of the 3D model of the dental appliance to conform to an auxiliary. Updated geometries that conform to an auxiliary are geometries that more closely conform to, or match, the geometry of the corresponding auxiliary compared with the 3D model of the dental appliance. Conform as described in this context includes corresponding auxiliary and appliance well geometries that are more similarly configured to one another than geometries of dental appliance initial 3D model and auxiliaries. Conform in this context includes corresponding auxiliary well and auxiliary geometries that apply a more desired force system than a geometry of an initial 3D model of the dental appliance and the auxiliary based on the orthodontic treatment plan.

Methods herein that are adapted to predict an updated geometry of an initial 3D model of a dental appliance may comprise trained models (algorithms) trained with a machine learning algorithm (learning algorithm). Trained models may be described herein generally as prediction models (PM), or overcured prediction models (OPM) specifically if the trained model is adapted to predict an updated geometry of the dental appliances that compensate for overcuring of a physical model of the auxiliary.

One aspect of this disclosure is related to methods of training machine learning algorithms such that the model, once trained, is adapted to predict an updated geometry of an initial 3D model of a dental appliance to conform to an auxiliary geometry.

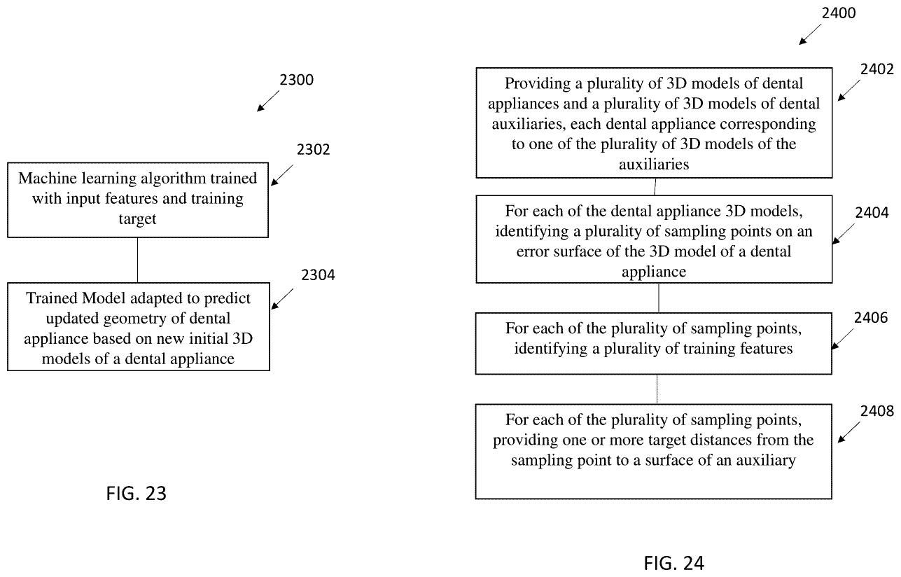

FIG. 23 illustrates an exemplary method 2300 of training a machine learning (“ML”) algorithm to create a trained model that is adapted to predict an updated geometry of a new initial 3D model of a dental appliance to conform to an auxiliary. Method 2300 includes, at step 2302, training an ML algorithm with input features and training targets. Once trained, at step 2304, the trained model is adapted to predict an updated geometry of a dental appliance based on new initial 3D model of the dental appliance.

Methods of training models may include providing input features that comprise a 3D model of a dental appliance, and model data (e.g., a scan) of an auxiliary that has been indirectly fabricated (e.g., thermoformed) on a physical model of dentition (e.g., mold), wherein the mold was 3D printed based on the 3D model of the auxiliary. Machine learning algorithms can be trained with inputs of the initial 3D model of the appliance and 3D model data (e.g., scans) of indirectly fabricated auxiliaries. The trained model is then adapted to receive a new initial 3D model of a dental appliance and predict an updated geometry of the 3D model of the appliance to conform to an auxiliary.

FIG. 24 illustrates an exemplary method 2400 of training an ML algorithm to create a trained model that is adapted to, once trained, predict an updated geometry of a new initial 3D model of a dental appliance (e.g., an auxiliary well) to conform to an auxiliary. Method 2400 includes, at step 2402, providing a plurality of 3D models of dental appliances and a plurality of 3D models of auxiliaries (e.g., scans), each dental appliance corresponding to one of the plurality of 3D models of the auxiliaries. For example, step 2402 may comprise providing a 3D model of an appliance generated with treatment planning system 2930 in FIG. 29, and a scan of an indirectly fabricated auxiliary, which may be obtained using intraoral scanning system 2910 in FIG. 29.

Method 2400 includes, at step 2404, for each of the appliance 3D models, identifying a plurality of sampling points on an error surface the 3D model of an appliance, examples of which are described herein for an error surface of an auxiliary.

Method 2400 includes, at step 2406, for each of the plurality of sampling points, identifying a plurality of training features for the sampling point. Training features as described herein may include one or more measurements from the sampling point, which may include measurements relative to points on the initial 3D model of the dental appliance auxiliary well. Training features may include one or more of dimension in the z-direction, dimension in the y-direction such as surface normal measurement, dimension in the x-direction, or distance to tooth, while other training features may also be used. Not all training features are necessarily used to train a model, depending on the desired application.

Method 2400 also includes, at step 2408, for each sampling point, providing one or more target distances from the sampling point to a surface of the 3D model of the auxiliary. The target distances may be measured in some or all of the training feature directions, or even alternative directions.

Method 2400 creates a trained model with parameters that can, upon receiving a new initial 3D model of a dental appliance, predict an updated geometry of the initial 3D model of a dental appliance to conform to an auxiliary.

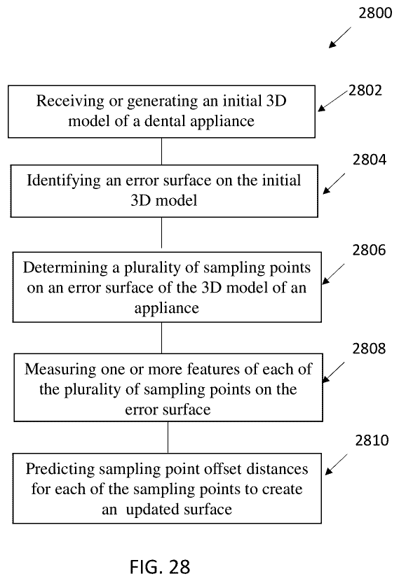

FIG. 28 illustrates an exemplary method 2800 which may be performed by a trained model, such as a model trained according to method 2400 in FIG. 24. Method 2800 is a method of predicting an updated geometry of an initial 3D model of an auxiliary well of dental appliance to conform to an auxiliary, and is an example of a particular implementation of the prediction method 2200 in FIG. 22. Method 2800 includes, at step 2802, receiving initial 3D model of a dental appliance, which may be generated in treatment planning system 2930 in FIG. 29. Method 2800 includes, at step 2804, identifying an error surface on the initial 3D model, such as error surface 2309 in FIGS. 25-27. Method 2800 includes, at step 2806, determining a plurality of sampling points on the error surface. Prediction method 2800 includes, at step 2808 measuring one or more features of each of the plurality of sampling points on the error surface, such as any of the feature dimension described herein (e.g., depth in z-direction, measurement in x direction, measurement in y direction such as surface normal measurement, or distance to tooth).

Prediction method 2800 further includes, at step 2810, based on the measured features of sampling points on the error surface of the new 3D model of the dental appliance, predicting offset dimensions for the sampling points, and thereby creating an updated surface of the new 3D model of the dental appliance that is predictive of an auxiliary geometry. Directly fabricated appliances, once their updated geometry is predicted, better predict or estimate the template attachment formed on a physical model of the dentition (e.g., thermoformed attachment). The updated geometry of the 3D model of the dental appliance, including the updated surface, facilitates a better force system for the dental appliance and auxiliary based on the orthodontic treatment.

Methods described herein than can predict an updated geometry of an auxiliary well of a dental appliance provide an estimation or prediction of an auxiliary surface. This can allow for more fabrication options to compensate for geometrical differences and achieve a better force system, which is described in more detail herein.

In general, these methods and apparatuses (systems, devices, etc., including software, hardware and/or firmware) may be used at one or more parts of a dental computing environment, including as part of an intraoral scanning system, doctor system, treatment planning (e.g., technician) system, patient system, and/or fabrication system. In particular, these methods and apparatuses may be used as part of treatment planning system 2930 and auxiliary and/or appliance fabrication system 2950. For example, methods of predicting updated geometries of one or more of an auxiliary or an appliance may occur in treatment planning system 2930, and methods of fabrication an auxiliary and/or an appliance may occur in auxiliary and/or appliance fabrication system 2950.

FIG. 29 is a diagram illustrating one variation of a computing environment 2900 that may generate one or more orthodontic treatment plans specific to a patient, and fabricate dental auxiliaries and appliances that may accomplish the treatment plan to treat a patient, under the direction of a dental professional. The example computing environment 2900 shown in FIG. 29 includes an intraoral scanning system 2910, a doctor system 2920, a treatment planning system 2930 (e.g., technician system), a patient system 2940, an auxiliary and/or appliance fabrication system 2950, and computer-readable medium 2960. Each of these systems may be referred to equivalently as a sub-system of the overall system (e.g., computing environment). Although shown as discrete systems, some or all of these systems may be integrated and/or combined. In some variations a computing environment (dental computing system) 2900 may include just one or a subset of these systems (which may also be referred to as sub-systems of the overall system 2900). As mentioned, one or more of these systems may be combined or integrated with one or more of the other systems (sub-systems), such as, e.g., the patient system and the doctor system may be part of a remote server accessible by doctor and/or patient interfaces. The computer readable medium 2960 may divided between all or some of the systems (subsystems); for example, the treatment planning system and auxiliary and/or appliance fabrication system may be part of the same sub-system and may be on a computer readable medium 2960. Further, each of these systems may be further divided into sub-systems or components that may be physically distributed (e.g., between local and remote processors, etc.) or may be integrated.

An intraoral scanning system may include an intraoral scanner as well as one or more processors for processing images. For example, an intraoral scanning system 2910 can include optics 2911 (e.g., one or more lenses, filters, mirrors, etc.), processor(s) 2912, a memory 2913, scan capture module 2914, and outcome simulation module 2915. In general, the intraoral scanning system 2910 can capture one or more images of a patient's dentition. Use of the intraoral scanning system 2910 may be in a clinical setting (doctor's office or the like) or in a patient-selected setting (the patient's home, for example). In some cases, operations of the intraoral scanning system 2910 may be performed by an intraoral scanner, dental camera, cell phone or any other feasible device.

The optical components 2911 may include one or more lenses and optical sensors to capture reflected light, particularly from a patient's dentition. The scan capture module 2914 can include instructions (such as non-transitory computer-readable instructions) that may be stored in the memory 2913 and executed by the processor(s) 2912 to control the capture of any number of images of the patient's dentition.

For example, the outcome simulation module 2915, which may be part of the intraoral scanning system 2910, can include instructions that simulate the tooth positions based on a treatment plan. Alternatively or additionally, in some examples, the outcome simulation module 2915 can import tooth number information from 3D models onto 2D images to assist in determining an outcome simulation.

Any of the component systems or sub-systems of the dental computing environment 2900 may access or use the 3D model of the patient's dentition generated by the methods and apparatuses described herein. For example, the doctor system 2920 may include a treatment management module 2921 and an intraoral state capture module 2922 that may access or use the 3D model. The doctor system 2920 may provide a “doctor facing” interface to the computing environment 2900. The treatment management module 2921 can perform any operations that enable a doctor or other clinician to manage the treatment of any patient. In some examples, the treatment management module 2921 may provide a visualization and/or simulation of the patient's dentition with respect to a treatment plan.

The intraoral state capture module 2922 can provide images of the patient's dentition to a clinician through the doctor system 2920. The images may be captured through the intraoral scanning system 2910 and may also include images of a simulation of tooth movement based on a treatment plan.

In some examples, the treatment management module 2921 can enable the doctor to modify or revise a treatment plan, particularly when images provided by the intraoral state capture module 2922 indicate that the movement of the patient's teeth may not be according to the treatment plan. The doctor system 2920 may include one or more processors configured to execute any feasible non-transitory computer-readable instructions to perform any feasible operations described herein.

Alternatively or additionally, the treatment planning system 2930 may include any of the methods and apparatuses described herein. The treatment planning system 2930 may include scan processing/detailing module 2931, segmentation module 2932, staging module 2933, treatment monitoring module 2934, and treatment planning database(s) 2935. In general, the treatment planning system 2930 can determine a treatment plan for any feasible patient. The scan processing/detailing module 2931 can receive or obtain dental scans (such as scans from the intraoral scanning system 2910) and can process the scans to “clean” them by removing scan errors and, in some cases, enhancing details of the scanned image. The treatment planning system 2930 may perform segmentation. For example, a treatment planning system may include a segmentation module 2932 that can segment a dental model into separate parts including separate teeth, gums, jaw bones, and the like. In some cases, the dental models may be based on scan data from the scan processing/detailing module 2931.

The staging module 2933 may determine different stages of a treatment plan. Each stage may correspond to a different dental aligner. The staging module 2933 may also determine the final position of the patient's teeth, in accordance with a treatment plan. Thus, the staging module 2933 can determine some or all of a patient's orthodontic treatment plan. In some examples, the staging module 2933 can simulate movement of a patient's teeth in accordance with the different stages of the patient's treatment plan.

The treatment monitoring module 2934 can monitor the progress of an orthodontic treatment plan. In some examples, the treatment monitoring module 2934 can provide an analysis of progress of treatment plans to a clinician. The orthodontic treatment plans may be stored in the treatment planning database(s) 2935. Although not shown here, the treatment planning system 2930 can include one or more processors configured to execute any feasible non-transitory computer-readable instructions to perform any feasible operations described herein.

The patient system 2940 can include a treatment visualization module 2941 and an intraoral state capture module 2942. In general, the patient system 2940 can provide a “patient facing” interface to the computing environment 2900. The treatment visualization module 2941 can enable the patient to visualize how an orthodontic treatment plan has progressed and also visualize a predicted outcome (e.g., a final position of teeth).

In some examples, the patient system 2940 can capture dentition scans for the treatment visualization module 2941 through the intraoral state capture module 2942. The intraoral state capture module can enable a patient to capture his or her own dentition through the intraoral scanning system 2910. Although not shown here, the patient system 2940 can include one or more processors configured to execute any feasible non-transitory computer-readable instructions to perform any feasible operations described herein.

The auxiliary and/or appliance fabrication system 2950 can include auxiliary and/or appliance fabrication machinery 2951, processor(s) 2952, memory 2953, and auxiliary and/or appliance generation module 2954. In general, the auxiliary and/or appliance fabrication system 2950 can directly or indirectly fabricate auxiliaries and/or aligners to implement an orthodontic treatment plan. In some examples, the orthodontic treatment plan may be stored in the treatment planning database(s) 2935.

The auxiliary and/or appliance fabrication machinery 2951 may include any feasible implement or apparatus that can fabricate any suitable auxiliary and/or dental aligner. The appliance generation module 2954 may include any non-transitory computer-readable instructions that, when executed by the processor(s) 2952, can direct the auxiliary and/or appliance fabrication machinery 2951 to produce one or more auxiliaries and/or dental aligners. The memory 2953 may store data or instructions for use by the processor(s) 2952. In some examples, the memory 2953 may temporarily store a treatment plan, dental models, or intraoral scans.

The computer-readable medium 2960 may include some or all of the elements described herein with respect to the computing environment 2900. The computer-readable medium 2960 may include non-transitory computer-readable instructions that, when executed by a processor, can provide the functionality of any device, machine, or module described herein.

The present disclosure contains the following clauses:

Clause 1. A method of forming a dental auxiliary, comprising: receiving or generating, by a processor, an initial three-dimensional (“3D”) model of a dental auxiliary, the initial 3D model having an initial geometry; predicting, by the processor, an updated geometry of the initial 3D model of the dental auxiliary to conform to an auxiliary well of a dental appliance, wherein predicting the updated geometry comprises: identifying an error surface on the initial 3D model of the dental auxiliary, wherein the error surface corresponds to a surface of the auxiliary well predicted to deviate from an original design of the dental appliance; adjusting the error surface of the 3D model of the dental auxiliary to create an updated surface, wherein the updated geometry defines a modified geometry that is different from the initial geometry of the 3D model of the dental auxiliary; and generating a digital representation of the dental auxiliary based on the updated geometry.

Clause 2. The method of Clause 1, wherein the dental auxiliary is a tooth attachment.

Clause 3. The method of Clause 1 or Clause 2, wherein the error surface corresponds to the surface of the auxiliary well that is predicted to deviate based on a fabrication technique.

Clause 4. The method of Clause 3, wherein the surface of the auxiliary well is predicted to deviate based on a manufacturing technique that is different than a manufacturing technique of the dental auxiliary.

Clause 5. The method of Clause 4, wherein the different manufacturing technique comprises a difference in orientation in which the dental auxiliary and the dental appliance are printed.

Clause 6. The method of Clause 5, wherein the difference in orientation includes opposite orientation, optionally wherein the dental appliance is printed bottom to top, and wherein the dental auxiliary is printed top to bottom.

Clause 7. The method of Clause 5, wherein the difference in orientation includes a difference in angle of printing, such as a 45 degree difference, or a 90 degree difference

Clause 8. The method of Clause 4, wherein the different manufacturing technique comprises a difference between indirect manufacturing and direct manufacturing.

Clause 9. The method of Clause 3, wherein the fabrication technique comprises 3D printing of a physical model of a patient's dentition, and the deviation is the result of a different 3D printing technique relative to the physical model.

Clause 10. The method of Clause 9, wherein the dental appliance, including the auxiliary well, is indirectly formed on the physical model.

Clause 11. The method of any of Clauses 1-10, wherein adjusting the error surface comprises varying a geometry of the error surface.

Clause 12. The method of Clause 11, wherein adjusting the error surface comprises extruding at least a portion of the error surface outward from a plane normal to the error surface.

Clause 13. The method of Clause 11 or Clause 12, wherein adjusting the error surface comprises intruding a portion of the error surface inward.

Clause 14. The method of any of Clauses 1-13, wherein adjusting the error surface comprises varying one or more of a surface, a shape, a contour of the error surface.

Clause 15. The method of any of Clauses 1-14, wherein the updated geometry defines a larger volume than a volume defined by the initial geometry.

Clause 16. The method of any of Clauses 1-14, wherein the updated geometry defines a volume that is the same as a volume defined by the initial geometry.

Clause 17. The method of any of Clauses 1-16, wherein predicting the updated geometry further comprises determining a plurality of sampling points on the error surface of the initial 3D model of the dental auxiliary, and measuring one or more features of each of the sampling points.

Clause 18. The method of Clause 17, further comprising, based on the one or more measured features, predicting a sampling point offset distance from the error surface for each of the plurality of sampling points, and using the sampling point offset distance to modify the error surface to create the updated surface.

Clause 19. The method of Clause 17 or Clause 18, wherein the one or more features of each of the sampling points comprise one or more of depth along a long axis in a z direction, a dimension in an x direction, a dimension in a y direction such as a surface normal measurement, or distance to tooth.

Clause 20. The method of any of Clauses 1-19, wherein the updated geometry of the 3D model of the dental auxiliary creates a better force system according to an orthodontic treatment between the dental auxiliary and the dental appliance than a force system between the initial geometry of the 3D model of the dental auxiliary and the dental appliance.

Clause 21. The method of any of Clauses 1-20, wherein the dental appliance is an aligner, a palate expander, or a retainer.

Clause 22. The method of any of Clauses 1-21, further comprising sending the digital representation to a client device.

Clause 23. The method of any of Clauses 1-22, further comprising displaying a visual representation of the digital representation on a user interface.

Clause 24. The method of any of Clauses 1-22, further comprising manufacturing the dental auxiliary based on the updated geometry.

Clause 25. The method of any of Clauses 1-24, further comprising: outputting direct fabrication instructions to manufacture the dental auxiliary that is based on the updated geometry; and receiving, by a direct fabrication machine, the direct fabrication instructions, and based on the received instructions, directly manufacturing the dental auxiliary with the fabrication machine according to the direct fabricate instructions.

Clause 26. The method of Clause 25, wherein directly fabricating the dental auxiliary comprises directly fabricating a removable positioner integrally formed with the dental auxiliary.

Clause 27. The method of Clause 26, wherein directly fabricating the dental auxiliary further comprises directly fabricating a plurality of dental auxiliaries each integrally formed with the removable positioner, each of the plurality of dental auxiliary comprising an updated geometry that is different than a corresponding initial 3D model data of the dental auxiliary.

Clause 28. The method of Clause 27, wherein directly fabricating the dental auxiliary comprises directly fabricating the dental auxiliary without directly fabricating an integral supporting structure coupled to the directly formed dental auxiliary.

Clause 29. The method of Clause 25, wherein directly manufacturing the dental auxiliary optionally comprises additive or subtractive processes.

Clause 30. The method of any of Clauses 1-29, wherein predicting the updated geometry of the 3D model of the dental auxiliary comprises predicting the updated geometry with a trained machine learning algorithm that has been trained to identify the error surface on the initial 3D model of the dental auxiliary and modify the error surface to create the updated surface.

Clause 31. The method of Clause 30, wherein the machine learning algorithm has been further trained to identify a plurality of sampling points on the error surface and to predict offset distances of the sampling points to modify the error surface of the 3D model of the dental auxiliary to create the updated surface.

Clause 32. The method of any of Clauses 1-31, wherein predicting the updated geometry of the 3D model of the dental auxiliary further comprises predicting a flash geometry between a tooth and the auxiliary, wherein the flash geometry includes a height y dimension normal to a tooth surface, and optionally also in a x dimension in a direction parallel along the tooth surface.

Clause 33. The method of any of Clauses 1-32, wherein predicting the updated geometry of the 3D model of the dental auxiliary further comprises predicting the addition of rounding or smoothing to one or more surfaces of the initial 3D model due to fabrication errors.

Clause 34. The method of Clause 33, wherein predicting added rounding is based on predicted added rounding due to a fabrication process in which the dental appliance does not fully wrap on a physical model of the dentition.

Clause 35. The method of Clause 33, wherein the fabrication errors are based on a difference in material between a physical model of dentition and a material of the dental appliance.

Clause 36. A method of forming a dental auxiliary, comprising: fabricating a dental auxiliary using a direct fabrication machine, wherein the direct fabrication machine receives a digital representation of the dental auxiliary that is generated by: receiving or generating, by a processor, an initial three-dimensional (“3D”) model of a dental auxiliary, the initial 3D model having an initial geometry; predicting, by the processor, an updated geometry of the initial 3D model of the dental auxiliary to conform to an auxiliary well of a dental appliance, wherein predicting the updated geometry comprises: identifying an error surface on the initial 3D model of the dental auxiliary, wherein the error surface corresponds to a surface of the auxiliary well predicted to deviate from an original design of the dental appliance; adjusting the error surface of the 3D model of the dental auxiliary to create an updated surface, wherein the updated geometry defines a modified geometry that is different from the initial geometry of the 3D model of the dental auxiliary; and generating a digital representation of the dental auxiliary based on the updated geometry.

Clause 37. A method of forming a dental appliance, comprising: receiving or generating, by a processor, an initial three-dimensional (“3D”) model of a dental appliance, the initial 3D model having an initial geometry; predicting, by the processor, an updated geometry of the initial 3D model of the dental appliance to conform to a dental auxiliary; wherein predicting the updated geometry comprises: identifying an error surface on the initial 3D model of the dental appliance, wherein the error surface corresponds to a surface of the dental auxiliary that is predicted to deviate from an original design of the dental auxiliary; adjusting the error surface of the 3D model of the dental appliance to create an updated surface, wherein the updated geometry defines a modified geometry that is different from the initial 3D model of a dental appliance; and generating a digital representation of the dental appliance based on the updated geometry.

Clause 38. The method of Clause 37, wherein the initial 3D model is an initial 3D model of an aligner, a palate expander, or a retainer.

Clause 39. The method of Clause 36 or Clause 37, wherein the error surface corresponds to the surface of the dental auxiliary that is predicted to deviate based on a manufacturing technique.

Clause 40. The method of Clause 39, wherein the surface of the dental auxiliary is predicted to deviate based on a manufacturing technique that is different than a manufacturing technique of the dental appliance.

Clause 41. The method of Clause 40, wherein the different manufacturing technique comprises a difference in direction in which the dental auxiliary and the dental appliance are printed.

Clause 42. The method of Clause 41, wherein the difference in direction is in opposite differences, optionally wherein the dental auxiliary is printed bottom to top, and wherein the dental appliance is printed top to bottom.

Clause 43. The method of Clause 41, wherein the difference in direction includes a difference in relative angle of printing, optionally a 180 degree difference, optionally a 45 degree difference, or optionally a 90 degree difference.

Clause 44. The method of Clause 40, wherein the different manufacturing technique comprises a difference between indirect manufacturing and direct manufacturing.

Clause 45. The method of Clause 39, wherein the manufacturing technique comprises 3D printing the dental appliance, and the predicted deviation is a result of a different 3D printing technique that occurs during a 3D printing of a physical model that includes the dental auxiliary.

Clause 46. The method of any of Clauses 37-45, wherein the auxiliary is indirectly formed on the physical model of the dentition.

Clause 47. The method of Clause 46, wherein adjusting the error surface comprises varying a geometry of the error surface.

Clause 48. The method of Clause 46, wherein adjusting the error surface comprises extruding at least a portion of the error surface outward.

Clause 49. The method of Clause 47 or Clause 48, wherein adjusting the error surface comprises intruding a portion of the error surface inward.

Clause 50. The method of any of Clauses 37-49 wherein adjusting the error surface comprises varying one or more of a surface, a shape, a contour of the error surface.

Clause 51. The method of any of Clauses 37-50, wherein the updated geometry defines a larger volume than a volume defined by the initial geometry.

Clause 52. The method of any of Clauses 36-49, wherein the updated geometry defines a volume that is the same as a volume defined by the initial geometry.

Clause 53. The method of any of Clauses 37-52, wherein predicting the updated geometry further comprises determining a plurality of sampling points on the error surface of the initial 3D model of the dental appliance, and measuring one or more features of each of the sampling points.

Clause 54. The method of Clause 53, further comprising, based on the one or more measured features, predicting a sampling point offset distance from the error surface for each of the plurality of sampling points, and using the sampling point offset distance to modify the error surface to create the updated surface.

Clause 55. The method of Clause 53 or Clause 54, wherein the one or more features of each of the sampling points comprise one or more of depth along a longitudinal axis of the dental auxiliary, dimension in an x direction, dimension in a y direction, a surface normal measurement, or distance to tooth.

Clause 56. The method of any of Clauses 37-55, wherein the updated geometry of the 3D model of the dental appliance facilitates a better force system based on an orthodontic treatment between the dental appliance and the auxiliary than a force system between the initial geometry of the 3D model of the dental auxiliary and the auxiliary.

Clause 57. The method of any of Clauses 47-56, wherein the dental auxiliary is a tooth attachment or other engagement feature.

Clause 58. The method of any of Clauses 37-57, further comprising sending the digital representation to a client device.

Clause 59. The method of any of Clauses 37-58, further comprising displaying a visual representation of the digital representation on a user interface.

Clause 60. The method of any of Clauses 37-58, further comprising manufacturing the dental appliance based on the updated geometry.

Clause 61. The method of any of Clauses 37-60, further comprising receiving, by a direct fabrication machine, the direct fabrication instructions, and based on the received instructions, directly manufacturing the dental appliance with the fabrication machine according to the direct fabricate instructions.

Clause 62. The method of Clause 61, wherein directly manufacturing the dental appliance comprises a manufacturing process, either additive or subtractive.

Clause 63. The method of Clause 62, wherein predicting the updated geometry of the 3D model of the dental appliance comprises predicting the updated geometry with a trained machine learning algorithm that has been trained to identify an error surface on the initial 3D model of the dental appliance and modify the error surface of the 3D model of the dental appliance to create the updated surface of the dental appliance.

Clause 64. The method of Clause 63, wherein the machine learning algorithm that has been additionally trained to identify a plurality of sampling points on the error surface and to predict offset distances of the sampling points to modify the error surface of the 3D model of the dental appliance to create the updated surface.

Clause 65. A method of training a machine learning prediction model to predict an updated geometry of a three-dimensional (“3D”) model of a dental auxiliary to conform to an auxiliary well of a dental appliance, comprising: providing 3D models of a plurality of dental auxiliaries, each including an error surface; providing 3D models of a plurality of dental appliances that each include an auxiliary receiving well, wherein each of the 3D models of the plurality of dental auxiliaries is associated with a corresponding auxiliary receiving well of one of the 3D models of the plurality of dental appliances; identifying a plurality of sampling points on each of the error surfaces; identifying a plurality of training features associated with each of the plurality of sampling points; and providing one or more target distances from each of the plurality of sampling points to a surface of the auxiliary receiving well to train the prediction model with the plurality of features associated with each of the plurality of sampling points and the target distances, wherein the trained prediction model is adapted to receive as input an initial 3D model of a dental auxiliary and, based on the initial 3D model of a dental auxiliary, predict an updated geometry of the 3D model of the dental auxiliary to conform to an auxiliary well of the dental appliance.

Clause 66. A method of training a machine learning prediction model to predict an updated geometry of a three-dimensional (“3D”) model of a dental appliance to conform to an auxiliary, comprising: providing 3D models of a plurality of dental appliances, each including an error surface in an auxiliary well; providing 3D models of a plurality of dental auxiliaries, wherein each of the 3D models of the plurality of dental auxiliaries is associated with a corresponding auxiliary receiving well of one of the 3D models of the plurality of dental appliances; identifying a plurality of sampling points on each of the error surfaces; identifying a plurality of features associated with each of the plurality of sampling points; and providing one or more target distances from each of the plurality of sampling points to a surface of the auxiliary to train the prediction model with the plurality of features associated with each of the plurality of sampling points and the target distances, wherein the trained prediction model is adapted to receive as input an initial 3D model of a dental appliance and, based on the initial 3D model of a dental appliance, predict an updated geometry of the 3D model of the dental appliance to conform to an auxiliary.

Clause 67. A system comprising: one or more processors; a memory coupled to the one or more processors, the memory storing computer-program instructions, that, when executed by the one or more processors, perform a computer-implemented method comprising: receiving or generating, by a processor, an initial three-dimensional (“3D”) model of a dental auxiliary, the initial 3D model having an initial geometry; predicting, by the processor, an updated geometry of the 3D model of the dental auxiliary to conform to an auxiliary well of a dental appliance, wherein predicting the updated geometry comprises: identifying an error surface on the initial 3D model of the dental auxiliary, wherein the error surface corresponds to a surface of the auxiliary well predicted to deviate from an original design of the dental appliance; modifying the error surface of the 3D model of the dental auxiliary to create an updated surface, wherein the updated geometry defines a modified geometry that is different from the initial geometry of the 3D model of the dental auxiliary; and generating a digital representation of the dental auxiliary based on the updated geometry.

Clause 68. A system comprising: one or more processors; a memory coupled to the one or more processors, the memory storing computer-program instructions, that, when executed by the one or more processors, perform a computer-implemented method comprising: receiving or generating, by a processor, an initial three-dimensional (“3D”) model of a dental appliance, the initial 3D model having an initial geometry; predicting, by the processor, an updated geometry of the initial 3D model of the dental appliance to conform to a dental auxiliary; wherein predicting the updated geometry comprises: identifying an error surface on the initial 3D model of the dental appliance, wherein the error surface corresponds to a surface of the dental auxiliary that is predicted to deviate from an original design of the dental auxiliary; modifying the error surface of the 3D model of the dental appliance to create an updated surface, wherein the updated geometry defines a modified geometry of an auxiliary well of the dental appliance that is different from the initial 3D model of a dental appliance; and generating a digital representation of the dental appliance based on the updated geometry.

Clause 69. A method of forming a dental auxiliary, comprising: receiving or generating, by a processor, an initial three-dimensional (“3D”) model of a dental auxiliary, the initial 3D model having an initial geometry; predicting, by the processor, an updated geometry of the initial 3D model of the dental auxiliary, wherein predicting the updated geometry comprises: identifying an error surface on the initial 3D model of the dental auxiliary; adjusting the error surface of the 3D model of the dental auxiliary to create an updated surface that is different than the error surface such that the updated geometry is different than the initial geometry; and generating a digital representation of the dental auxiliary based on the updated geometry.

Clause 70. The method of Clause 69, wherein the error surface corresponds to a surface of an auxiliary well predicted to deviate from an original design of the dental appliance.

Clause 71. The method of Clause 69, wherein adjusting the error surface of the initial 3D model comprises predicting an overcure geometry associated with the initial 3D model and adjusting the error surface of the 3D model to create the updated geometry to compensate for the predicted overcure geometry.

Clause 72. The method of Clause 71, wherein fabricating a dental auxiliary based on the updated geometry comprises fabricating a dental auxiliary with a geometry that conforms to or resembles the initial 3D model.

What is claimed is:

1. A method of forming a dental auxiliary, comprising:
receiving or generating, by a processor, an initial three-dimensional (“3D”) model of a dental auxiliary, the initial 3D model having an initial geometry;
predicting, by the processor, an updated geometry of the initial 3D model of the dental auxiliary to conform to an auxiliary well of a dental appliance,
wherein predicting the updated geometry comprises:
identifying an error surface on the initial 3D model of the dental auxiliary, wherein the error surface corresponds to a surface of the auxiliary well predicted to deviate from an original design of the dental appliance;
adjusting the error surface of the 3D model of the dental auxiliary to create an updated surface,
wherein the updated geometry defines a modified geometry that is different from the initial geometry of the 3D model of the dental auxiliary; and
generating a digital representation of the dental auxiliary based on the updated geometry.

2. The method of claim 1, wherein generating comprises receiving, by a direct fabrication machine, the digital representation of the dental auxiliary based on the updated geometry and manufacturing the dental auxiliary with the fabrication machine according to the digital representation.

3. The method of claim 1, wherein the dental auxiliary is a tooth attachment.

4. The method of claim 1, wherein the error surface corresponds to the surface of the auxiliary well that is predicted to deviate based on a fabrication technique specific to the direct fabrication machine.

5. The method of claim 1, wherein the surface of the auxiliary well is predicted to deviate based on a manufacturing technique that is different than a manufacturing technique of the dental auxiliary.

6. The method of claim 5, wherein the different manufacturing technique comprises a difference in orientation in which the dental auxiliary and the dental appliance are printed.

7. The method of claim 6, wherein the difference in orientation includes opposite orientation, optionally wherein the dental appliance is printed bottom to top, and wherein the dental auxiliary is printed top to bottom.

8. The method of claim 6, wherein the difference in orientation includes a difference in angle of printing, such as a 45 degree difference, or a 90 degree difference.

9. The method of claim 5, wherein the different manufacturing technique comprises a difference between indirect manufacturing and direct manufacturing.

10. The method of claim 4, wherein the fabrication technique comprises 3D printing of a physical model of a patient's dentition, and the deviation is the result of a different 3D printing technique relative to the physical model.

11. The method of claim 10, wherein the dental appliance, including the auxiliary well, is indirectly formed on the physical model.

12. The method of claim 1, wherein adjusting the error surface comprises varying a geometry of the error surface.

13. The method of claim 1, wherein adjusting the error surface comprises extruding at least a portion of the error surface outward from a plane normal to the error surface.

14. The method of claim 1, wherein adjusting the error surface comprises intruding a portion of the error surface inward.

15. The method of claim 1, wherein predicting the updated geometry further comprises determining a plurality of sampling points on the error surface of the initial 3D model of the dental auxiliary, and measuring one or more features of each of the sampling points.

16. The method of claim 1, wherein the dental appliance is an aligner, a palate expander, or a retainer.

17. A method of forming a dental auxiliary, comprising:
fabricating a dental auxiliary using a direct fabrication machine, wherein the direct fabrication machine receives a digital representation of the dental auxiliary that is generated by:
receiving or generating, by a processor, an initial three-dimensional (“3D”) model of a dental auxiliary, the initial 3D model having an initial geometry;
predicting, by the processor, an updated geometry of the initial 3D model of the dental auxiliary to conform to an auxiliary well of a dental appliance,
wherein predicting the updated geometry comprises:
identifying an error surface on the initial 3D model of the dental auxiliary, wherein the error surface corresponds to a surface of the auxiliary well predicted to deviate from an original design of the dental appliance;
adjusting the error surface of the 3D model of the dental auxiliary to create an updated surface,
wherein the updated geometry defines a modified geometry that is different from the initial geometry of the 3D model of the dental auxiliary; and
generating a digital representation of the dental auxiliary based on the updated geometry.

18. A method of forming a dental appliance, comprising:
receiving or generating, by a processor, an initial three-dimensional (“3D”) model of a dental appliance, the initial 3D model having an initial geometry;
predicting, by the processor, an updated geometry of the initial 3D model of the dental appliance to conform to a dental auxiliary;
wherein predicting the updated geometry comprises:
identifying an error surface on the initial 3D model of the dental appliance, wherein the error surface corresponds to a surface of the dental auxiliary that is predicted to deviate from an original design of the dental auxiliary;
adjusting the error surface of the 3D model of the dental appliance to create an updated surface,
wherein the updated geometry defines a modified geometry that is different from the initial 3D model of a dental appliance; and
generating a digital representation of the dental appliance based on the updated geometry.

19. The method of claim 18, wherein predicting the updated geometry of the 3D model of the dental auxiliary comprises predicting the updated geometry with a trained machine learning algorithm that has been trained to identify the error surface on the initial 3D model of the dental auxiliary and modify the error surface to create the updated surface.

20. The method of claim 19, wherein the machine learning algorithm has been further trained to identify a plurality of sampling points on the error surface and to predict offset distances of the sampling points to modify the error surface of the 3D model of the dental auxiliary to create the updated surface.
